(19) United States
(12) Patent Application Publication
(10) Pub. No.: US 2013/0222373 A1
(43) Pub. Date: Aug. 29, 2013

(54) COMPUTER PROGRAM, SYSTEM, METHOD AND DEVICE FOR DISPLAYING AND SEARCHING UNITS IN A MULTI-LEVEL STRUCTURE

(71) Applicant: Evolution Ventures LLC, (US)

(72) Inventors: Eyal Weinstein, Miami Beach, FL (US); Jonathan Oleinick, Miami Beach, FL (US)

(73) Assignee: Evolution Ventures LLC, Miami Beach, FL (US)

(21) Appl. No.: 13/857,446

(22) Filed: Apr. 5, 2013

Related U.S. Application Data
(63) Continuation of application No. PCT/US2011/053469, filed on Sep. 27, 2011.
(60) Provisional application No. 61/389,966, filed on Oct. 5, 2010.

(51) Int. Cl. G06T 15/00

(52) U.S. Cl. CPC G06T 15/00
USPC 345/419

(57) ABSTRACT

A computer program, method, system and device for displaying a three-dimensional rendering of a multi-level structure having a plurality of units, involving displaying a viewpoint of a three-dimensional rendering of the multi-level structure, wherein the viewpoint can display information about a unit in the plurality of units of the multi-level structure that is visible within the viewpoint, and optionally allowing the plurality of units to be searched and graphically marking units which meet the search criteria of the search.

### CROSS REFERENCE TO RELATED APPLICATIONS

This application is a continuation of PCT Application No. PCT/US2011/53469, filed Sep. 27, 2011, which claims priority to U.S. Provisional Application Ser. No. 61/389,966, filed Oct. 5, 2010, the entirety of which is incorporated herein by reference in its entirety.

### BACKGROUND AND FIELD OF ART

The invention generally relates to the field of displaying information about multi-level structures.

Multi-level structures, as used in this disclosure, broadly encompass any structure with vertically stacked units or stories. The most common example of a multi-level structure is a building, such as a condominium, apartment building, dormitory, hotel, house, office building, hospital, penitentiary, self-storage building, convention center, shopping mall, factory, warehouse, stadium, or theatre. Ships are another exemplary type of a multi-level structure, and include passenger ships, cruise ships, and military vessels. Units are the sub-structures that occupy space within a multi-level structure. For example, in apartment buildings, a unit generally refers to an individual apartment. In a dormitory or hotel, a unit might be a room or a suite. And in a ship a unit might be a passenger cabin. Units are often associated with data about the features or characteristics of the unit.

Numerous situations and circumstances call for a person to search and analyze information about units in a multi-story structure. For example, in the real estate marketplace, buyers and renters consider numerous variables when selecting units in multi-story buildings. Such variables include building location, unit location within the building, price of a unit, size, amenities, views, layout, unit fixtures and building amenities.

To more effectively search, sort and analyze information about real estate, a number of electronic search systems have been developed. Such search systems, which are principally configured for use with single-level structures, allow a user to quickly identify units that meet specific search criteria across one or more of the variables noted above. Presently available search systems generally provide search results for real estate unit searches in long lists, spreadsheets, 2-dimensional maps, 2-dimensional grids or multiple floor plans.

One existing system that allows a user to evaluate information about the real estate marketplace is Zillow (www.zillow.com) Zillow, along with other similar software applications and tools, allows a user to filter multi-story real estate units by a range of criteria and receive the search results in list format (see FIG. 1), or 2-dimensional map view (see FIG. 2). As shown in FIG. 1, within a list view, units are shown in a series of results that match the search criteria, each result showing information about a unit, such as addresses, size, prices, last sale dates and other unit-specific information. Selecting an individual unit from the list directs the user to a new electronic screen with more detailed information about that unit. In the case of Zillow, this detailed information may include unit pictures, floor plans, unit statistics and other more detailed information.

Another existing system that allows searching and display of is provided on certain condominium or apartment web sites. Such web sites allow a user to view floor plans for each level of a building. Occasionally these floor plans are interactive, and allow the user to access information about a unit of interest.

Unfortunately, there are significant limitations and drawbacks to currently available systems for searching and displaying information about units in multi-level structures. These include limitations and drawbacks associated with analyzing search result in long lists, spreadsheets, 2-dimensional maps, 2-dimensional grids, 2-dimensional stacked plans or multiple floor plans.

First, list views and spreadsheets do not convey graphic information about the visual or spatial location of units relative to other units, a building, or nearby buildings. More specifically, list views and spreadsheets do not illustrate unit location within a building and relative to neighboring buildings. Additionally, list views and spreadsheets do not illustrate, unit orientation, size relative to other units, building level or other salient features of high interest to a user. As a result, it is difficult if not impossible for a user to fully assess or consider a unit's characteristics by using search results in the form of mere list views and spreadsheet information.

Second, as shown in FIG. 2, 2-dimensional map view displays of multi-story real estate unit searches place markers (sometimes showing unit price) on 2-dimensional maps showing the geographical locations of unit results. While search results for a single story building may be accurate in such systems, search results for a multi-story building are placed approximately, or may simply be placed anywhere within the bounds of the building to which they pertain. Accordingly, the units can appear directly on top of one another and obscure each other when they are on top of each other in the actual real estate or when markers are placed too closely together.

In addition, often only one icon, or marker, will be used to represent graphically all the listings for a single building to avoid displaying the results on top of one another or placed spatially incorrectly side by side. By selecting a marker, a user may be shown more detailed information of the units, by being directed to another page with more detailed unit information, or to a list of all units represented by that icon or marker. Showing unit locations within 2-dimensional maps will often help to analyze a multi-story buildings unit's proximity to surrounding geographical landmarks like nearby cities, beaches, shopping areas, etc. However, this method of displaying multi-story unit search results does not allow the user to see where the units are located and how they are oriented within the building, relative to one another and other landmarks.

Third, as shown in FIG. 3, 2-dimensional grids display search results in grids or tables of written unit information where columns represent unit types and rows represent building floors. These formats are used for showing and comparing unit pricing, sizes and others features. However, they only show approximate relative positioning of the units, and do not visually convey how the units are located within the actual building, which directions they face, their relative sizes, if they are corner units and many other salient directional and physical features.

Fourth, multi-level real estate is often displayed using 2-dimensional floor plans corresponding with each individual floor. These can show the relative location, size and configuration of units within a floor, but only show one floor at a time. However, the use of floor plans corresponding with each floor as a way to display or compare unit information quickly becomes unmanageable as the number of floors in a building increase, or as additional structures are added to the list of structures to be viewed or searched. Moreover, the use of multiple floor plans makes it nearly impossible to accurately convey visual or spatial information to compare the locations relative to multiple units on multiple floors because users must bring up each of the floor plans and the respective information about the units. This requires the use of numerous browser windows to compare more than one unit.

Each of the above-described systems and methods displays unit information and search results through the described two-dimensional approaches, which are fractured, time consuming and confusing. Also, spatial relationships of units to one another are not intuitively explained in these types of displays.

Furthermore, although the above description focused on the real estate marketplace, the same problems relating to the vertical stacking of units are also present in the searching of or display of information about units of all multi-level structures in any context.

Therefore, there is a need in the art to address the limitations associated with the searching and/or display of information pertaining to units in a multi-level structure.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention is generally directed to a system, method, device and computer program product for displaying a three-dimensional rendering of a multi-level structure having a plurality of units, displaying information relating to those units, and/or allowing search queries to be conducted on the information relating to the units and graphically marking the units meeting the search criteria on the displayed three dimensional rendering.

One embodiment of the invention involves a method for displaying a three-dimensional rendering of a multi-level structure having a plurality of units, wherein a viewpoint of a three-dimensional rendering of the multi-level structure is displayed, which is capable of marking a unit and displaying information about a unit of the plurality of units of the multi-level structure that is visible within the viewpoint. Optionally this embodiment may allow a search query having certain search criteria to be entered, and may graphically mark and/or display information about all units meeting the search criteria that are visible in the viewpoint of the multi-level structure.

In another embodiment of the invention, an electronic device for displaying a three-dimensional rendering of a multi-level structure having a plurality of units, may include an input device and a display device which is capable of displaying a viewpoint of a three-dimensional rendering of a multi-level structure, and is further capable of marking and displaying information about one of the plurality of units of the multi-level structure. Optionally this embodiment may allow a search query having certain search criteria to be entered through the input device, and may graphically mark all units meeting the search criteria that are visible in the viewpoint of the multi-level structure.

In another embodiment, a system for displaying a three-dimensional rendering of a multi-level structure having a plurality of units, may include a database containing information about the plurality of units of the multi-level structure, and a computing device comprising a display device and capable of displaying a viewpoint of a three-dimensional rendering of the multi-level structure on the display device. Optionally this embodiment may allow a search query having certain search criteria to be entered, and may graphically mark all units meeting the search criteria that are visible in the viewpoint of the multi-level structure.

In another embodiment, a computer program product, comprising a computer usable medium having a computer readable program code embodied therein, said computer readable program code adapted to be executed to display a three-dimensional rendering of a multi-level structure having a plurality of units, said method may include displaying a viewpoint of a three-dimensional rendering of the multi-level structure, wherein the viewpoint is capable of displaying information about a unit of the plurality of units of the multi-level structure that is visible within the viewpoint. Optionally this embodiment may allow a search query having certain search criteria to be entered, and may graphically mark all units meeting the search criteria that are visible in the viewpoint of the multi-level structure.

In another embodiment, based on any of the previously described embodiments, the three dimensional rendering of the multi-level structure may be replaced with a snapshot or video feed of a real-life multi-level structure or a realistic rendering environment, having a plurality of units, and the snapshot, video feed or realistic rendering environment may be augmented by either displaying a graphically marked unit over the snapshot, video feed or rendering environment (with or without displaying information about the unit), or by allowing the units in the multi-level structure to have a search query having certain search criteria entered, and graphically marking the units meeting the search criteria on the building.

### BRIEF DESCRIPTION OF THE DRAWINGS

FIG. 1 illustrates a prior art system's list view of the units resulting from a search query pertaining to a multi-story building.

FIG. 2 illustrates a prior art system's two-dimensional map of the units resulting from a search query pertaining to a multi-story building.

FIG. 3 illustrates a prior art two dimensional pricing sheet where units on lower floors are on the bottom of the page and units on higher floors are nearer to the top of the page.

FIG. 4 illustrates a prior art building schematic on the left and a floor plan for the specified floors on the right, from a prior art website.

FIG. 5 illustrates an example of a suitable computing system environment on which features of the invention may be implemented.

FIG. 6 illustrates an embodiment of the invention showing a viewpoint of a three-dimensional multi-story real estate rendering with a graphical user interface at the bottom.

FIG. 7 illustrates an embodiment of the invention showing a viewpoint of a three-dimensional multi-story real estate rendering with a graphical user interface at the bottom wherein information about the units is displayed by graphically marking the units.

FIG. 8 illustrates the embodiment in FIG. 6, wherein the viewpoint has been “zoomed in” to display certain units and display their respective information, and the graphical user interface has been minimized.

FIGS. 9a and 9b illustrate the embodiments of the invention, wherein a search query has been entered into the graphical user interface, and the units which meet the search criteria have been graphically marked.

FIG. 10 illustrates an embodiment, wherein another search query has been entered into the graphical user interface, and the units which meet the search criteria have been graphically marked in different ways.

FIG. 11 illustrates the embodiment shown in FIG. 8, wherein a list view of the search results is presented in lieu of the viewpoint of the three-dimensional rendering of the multi-story building.

FIG. 12 illustrates the embodiment shown in FIG. 6, wherein a front view of the building selected.

FIG. 13 illustrates the embodiment of the invention shown in FIG. 6, wherein a side view of the building is selected.

FIG. 14 illustrates the embodiment of the invention shown in FIG. 6, wherein a unit detail page is being displayed.

FIG. 15 illustrates the embodiment of the invention shown in FIG. 6, wherein the floor plan page of a unit is being displayed.

FIG. 16 illustrates the embodiment of the invention shown in FIG. 6, wherein a unit picture gallery page is being displayed.

FIG. 17 illustrates an embodiment of the invention showing how an internal unit might be displayed.

FIGS. 18a and 18b illustrate an embodiment of the invention wherein multiple multi-story buildings are being simultaneously displayed and searched.

FIG. 19 illustrates a flow chart of a method for displaying and/or searching units of a multi-story building in accordance with an embodiment of the invention.

FIG. 20 illustrates a high level view of a system architecture in accordance with an embodiment of the invention.

FIG. 21 illustrates an embodiment of the invention having an administrative tool to manage a database containing information relating to a multi-story building and its units, showing the unit information page from the administrative tool.

FIG. 22 illustrates an embodiment of the invention having an administrative tool to manage a database containing information relating to a multi-story building and its units, showing the unit plan page from the administrative tool.

### DETAILED DESCRIPTION OF ILLUSTRATIVE EMBODIMENTS OF THE INVENTION

The present invention is generally directed to a system, method, device and computer program product for displaying a three-dimensional rendering of a multi-level structure having a plurality of units, displaying information relating to those units, and/or allowing search queries to be conducted on the information relating to the units and graphically marking the units meeting the search criteria on the displayed three dimensional rendering. Accordingly, implementations of the invention include, or involve the use of computing devices.

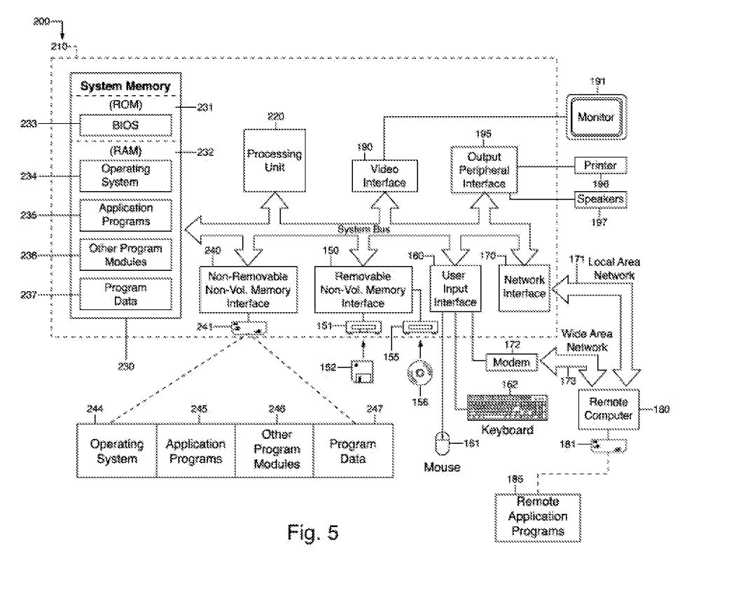

Specifically, embodiments of present invention may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc. An exemplary computing device for implementing a computational device is illustrated in FIG. 5.

FIG. 5 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system that may be used for implementing the invention includes a computing device 210 which may be used for implementing a client, server, mobile device or other suitable environment for the invention. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 5 illustrates operating system 234, application programs 235, other program modules 236, and program data 237.

The computing device 210 may also include other removable/non-removable, volatile/nonvolatile computer storage media. By way of example only, FIG. 5 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

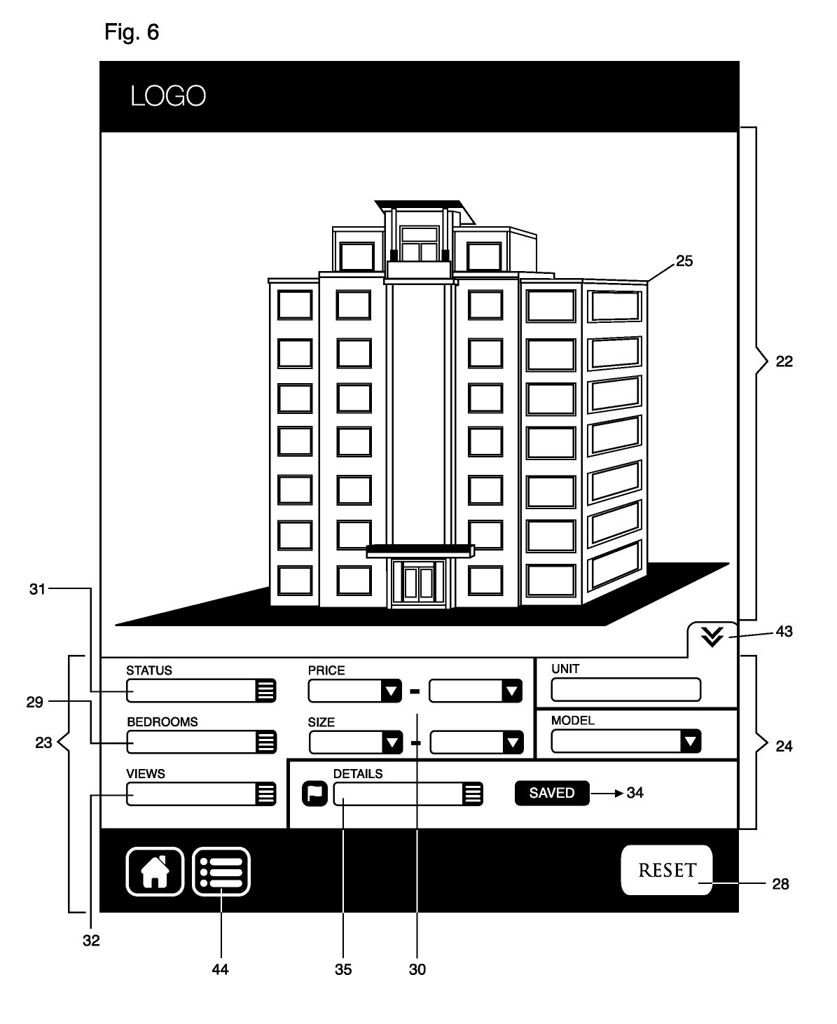

The drives and their associated computer storage media discussed above and illustrated in FIG. 6, provide storage of computer readable instructions, data structures, program modules and other data for the computing device 210. In FIG. 5, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 5. The logical connections depicted in FIG. 5 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 5 illustrates remote application programs 185 as residing on memory device 181. It will be appreciated that the network connections shown are exemplary and other means of establishing a communications link between the computers may be used.

The invention is generally directed to a method, system, device and computer program product wherein a multi-level structure having a plurality of units can be rendered in three dimensions.

FIGS. 6-17 illustrate exemplary embodiments of the invention directed to the display of a multi-level structure—a multi-story building, such as a condominium—for a real estate market application depicting information about units that are offered for sale. However, persons of skill in the art will recognize that the descriptions and methodology described herein can be easily applied to real estate and other multi-level structures in other contexts. Accordingly, the foregoing descriptions are intended as illustrative, and not as limiting. Additionally, persons of ordinary skill in the art will recognize that when a description refers to one unit being displayed, manipulated, or one unit meeting search criteria, the description equally applies to multiple units being displayed, manipulated or meeting search criteria. Thus, descriptions in the singular may disclose the plural and vice versa.

FIG. 6 illustrates a three dimensional page (or screen or window), which may be the top or starting page, of an embodiment of the invention. The three dimensional page may display a viewpoint of a three-dimensional rendering of a multi-story building 25 having a plurality of units, in a rendering display area 22. The rendering display area 22 shown in FIG. 6 depicts a perspective view of only the multi-story building 25. However, in other embodiments, internal or external amenities of the building (pool, tennis courts, party rooms, parking lots laundry rooms, hallways, lobby areas, etc.) and other structures and landscape features surrounding the building, such as other buildings, roads, trees, mountains, bodies of water, etc., may be rendered and shown in the rendering display area as well. In some embodiments, the view point of the three dimensional rendering may be rotated, panned, zoomed in, or zoomed out in order to show the user different views of the multi-story building.

The three dimensional rendering can be accomplished through the use of industry standard game/three dimensional environment engines (such as Unity, Gamebryo, Unreal, and a myriad of others), standard graphical libraries (such as DirectX, OpenGL, Flash, HTML 5 and others), proprietary graphics display coding, or any other methods known in the art for rendering and displaying three dimensional images. Likewise, the three dimensional models of the multi-story building 25, as well as any surrounding buildings, trees and other landscape features that may be displayed in the rendering display area 22 can be made with industry standard software, (such as 3D Studio Max, Maya, Blender, Google Sketch Up, etc.), can be hard-coded into the implementation, or can be made through any other methods known in the art for making three dimensional models. In certain embodiments, in addition to the three dimensional model of the multi-level structure, marking overlays may be made for use in graphically marking the units of the multi-level structure. These marking overlays may be a three dimensional model that follows the shape of the respective units which they are to graphically mark, and may include additional information (such as the level and side(s) of the multi-level structure that a unit is on, the viewpoint(s) from which the unit may be visible, etc.) about the unit to help an embodiment of the invention determine when the marking overlay should be displayed, and are designed to be visible when drawn together with the multi-level structure. Each unit may have its own specialized model, or units having similar floor plans can use copies of the same model.

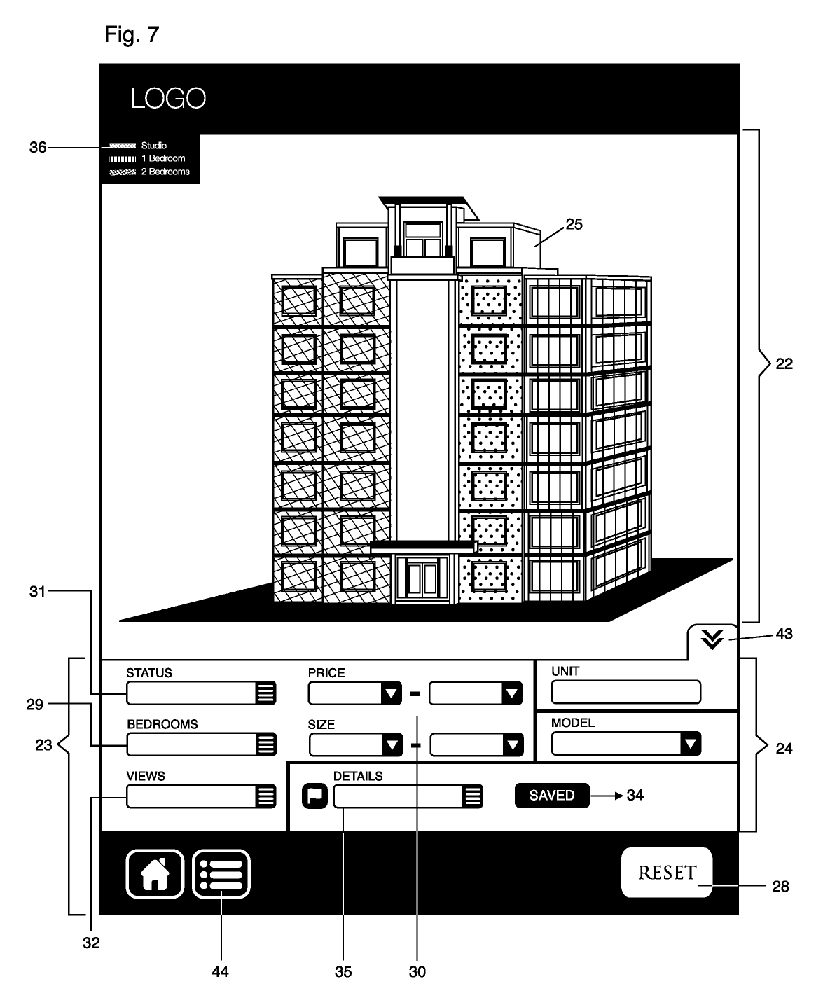

As shown in FIG. 7, in some embodiments, information about the individual units may be displayed on the rendering display area 22, prior to any search queries being run. For example, the boundaries of each unit may be highlighted, or otherwise graphically marked to visually indicate to the user the status of the unit (as sold, active, closed, pending, reserved, etc.) or the number of bedrooms in a unit at a glance. Other examples may include displaying the unit number or other key information (such as price, size, number of bedrooms, pictures, videos, etc.) visually over (within), partially over or adjacent to the rendering of each unit, or connected to the unit by a line or arrow, or in a separate window, box or pane. Additionally, the unit may be graphically marked, in any of the ways discussed below, such that the graphical marking of the unit represents the information being displayed. Any type of information may be displayed or otherwise graphically represented, including status, key information, and any other information related to the unit. In embodiments that use a mouse as an input device, key information can be displayed in a mouse over bubble or temporary pop-up window whenever the mouse cursor passes over a unit that is being displayed in the rendering display area.

The graphical marking of units can be performed in any suitable manner that allows the marked units to be visually distinguished from unmarked units. Some examples of how units can be marked include, without limitation: in embodiments implemented in color, the graphical marking can consist of highlighting a unit a particular color (as discussed above); using marking overlays; displaying an icon associated with the search over the unit; drawing an outline of the unit in a particular color or with bolded or otherwise distinguishable edges, superimposing a pattern over the unit, outlining of the borders or edges of the unit with a selected color and displaying an icon over the unit; adjusting its transparency relative to unmarked units; using a texture; using arrows; using lines; modifying the width of the lines along the edges of the unit; using text; using photographs; using video; using animations; using floor plans; or any other suitable method of graphically marking a unit. The graphical marking can be limited to a designating a point or region within the boundaries of the unit on the exterior of the building representing the unit, or using the entire 3D volume of the unit may be highlighted or otherwise graphically marked. Marked units may become bolded or brighter, while unmarked units may be darkened, or become partially or totally translucent, transparent or blurred. A unit might be shown with a partially or totally translucent exterior façade to allow the viewer to see details of interior contents such as furniture, interior walls, etc. Any other methods that enable a user to visually identify the units being graphically marked may be used.

Information relating to the units may also be displayed by rendering the multi-story building 25 such that the units in the building 25 are graphically marked based on their characteristics. For example, in FIG. 7 the units are graphically marked such that studio, one bedroom, two bedroom, are each rendered such that they are highlighted with a particular pattern—a slanted pattern for studios, a dotted pattern for one bedroom units, and a dashed line pattern for two bedroom units. A legend 36 may be included to show the user what the different graphical markings represent. Other methods of graphically marking these units include color coding the units assigning a different color to each category (here, number of bedrooms), or by marking each unit with an icon or symbol specific to the category of unit. The graphical marking of the units can be done by manipulating the rendering of the unit on the building directly, or through the use of marking overlays, as described above. Alternatively, the units may be graphically marked to indicate their status (i.e. active, closed, pending, reserved, etc.), view (city, water, landmark, etc.), price range, price per square foot, and other such pertinent information.

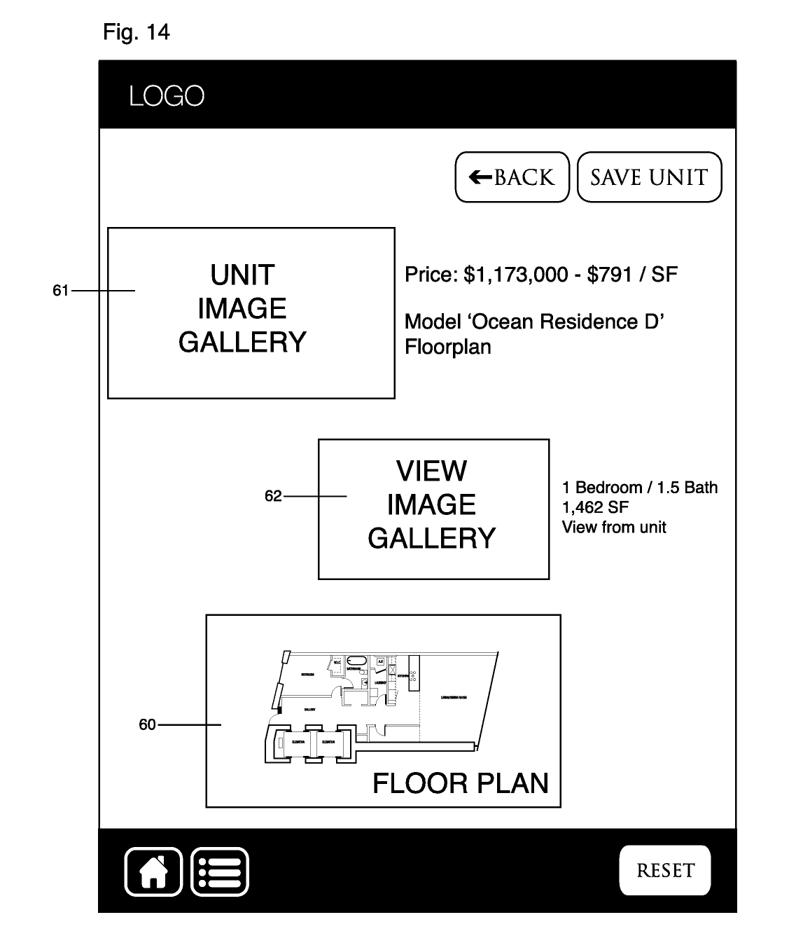

In certain embodiments a user interface, commonly a graphical user interface, is used to allow a user to manipulate and use the invention. FIG. 6, also shows a graphical user interface 23. The relationship between the graphical user interface and the rendering display may vary from embodiment to embodiment of the invention. In some embodiments the graphical user interface may be implemented either in split screen fashion, as an overlay on top of the rendering display area 22, or in any other manner known in the art. The graphical user interface may include a search options panel 24, which provides a user with options which can be used to formulate a search query which the invention will process and will mark the units in the building that meet the criteria set forth in the search query. Some of the types of search options that may be presented in the search options panel 24 include size and price information 30, number of bedrooms 29, unit status 31 (active, closed, pending, reserved, closed, sold, etc.), views from the unit 32(city, water, major landmarks, etc.), model name (for condominiums having names for unit types), number of bathrooms, keyword searches of the descriptions of the units, unit owner, historical sales information, loan information, property taxes etc. The graphical user interface may also have a details panel (or a details panel button 35, which brings up a details panel) which enables the user to select the type of information that the user would like displayed for each unit that meets search criteria. In some embodiments there is a default setting for the types of information to be displayed, but the user can edit same to add to or subtract from the types information displayed. In some embodiments the user can save his preferred set or sets of information to be displayed. In some embodiments, a reset button 28 is provided, which allows the user to cancel any search queries that have been run, and return to the top screen as it existed before any searches were run. Additionally, a “Saved Units” button 34 may be provided which allows the user to recall and display units that had previously been saved, as described more fully below with respect to FIG. 14.

The information that can be searched is kept in a database that maintains a wide variety of unit information on each unit, including, but not limited to unit number, size, price, price per square foot, amenities, number of rooms, number of bedrooms, number of bathrooms, view type and sale status. The database can also contain links to content files such as pictures of the units and views, floor plans, 3D rendering of interior space and other unit and building media. As explained in greater detail below, the database may be a central (though not necessarily centralized) database which maintains information on all units in a single location that is accessed directly or remotely. The database may also be a local database resident on the same machine that is performing the rendering operations. In other embodiments, both local and a master database may be used, wherein the local database(s) is periodically updated by the master database.

The graphical user interface is generally two-dimensional, and can be displayed through the use of the two-dimensional display functionality of the game engines, graphics libraries, and other methods discussed above. Similarly, any other known methods of displaying a graphical user interface can be used to practice the invention.

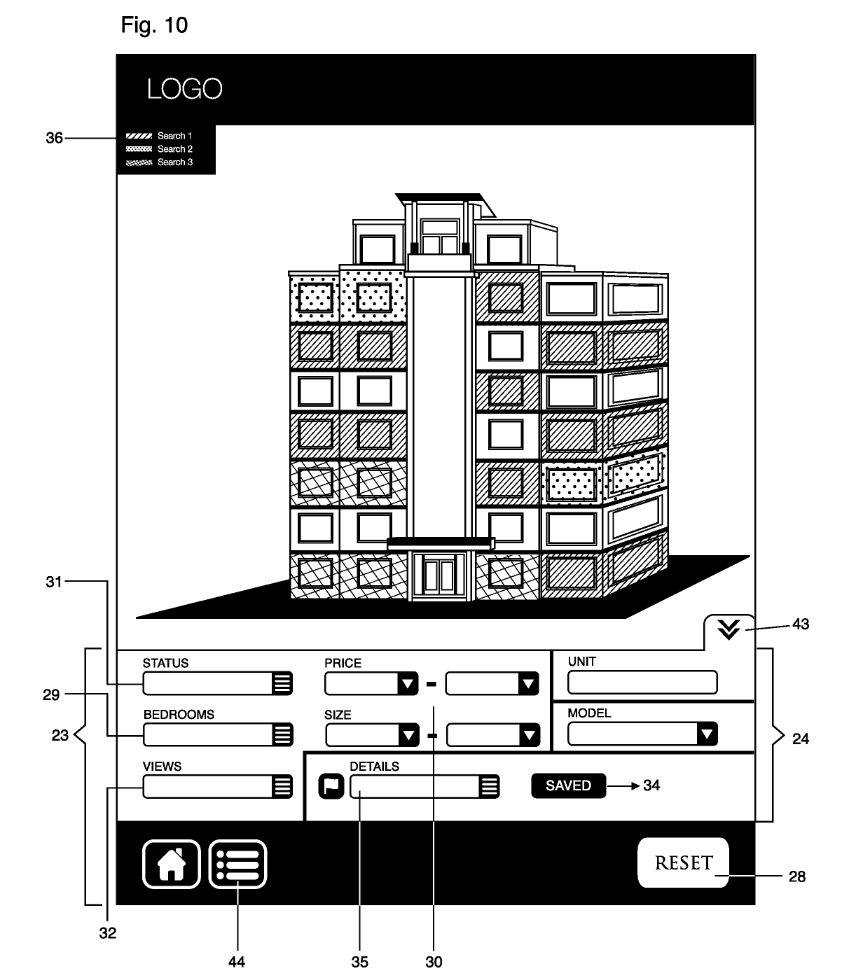

In some embodiments, the graphical user interface may optionally have an interface toggle button, 43, which can hide a portion, or all of the graphical user interface. In some embodiments he graphical user interface may also have a list button 44, which can cause a list of units that also meet search criteria from the search query to be displayed, and may resemble certain prior art lists (see the discussion of FIG. 10 below).

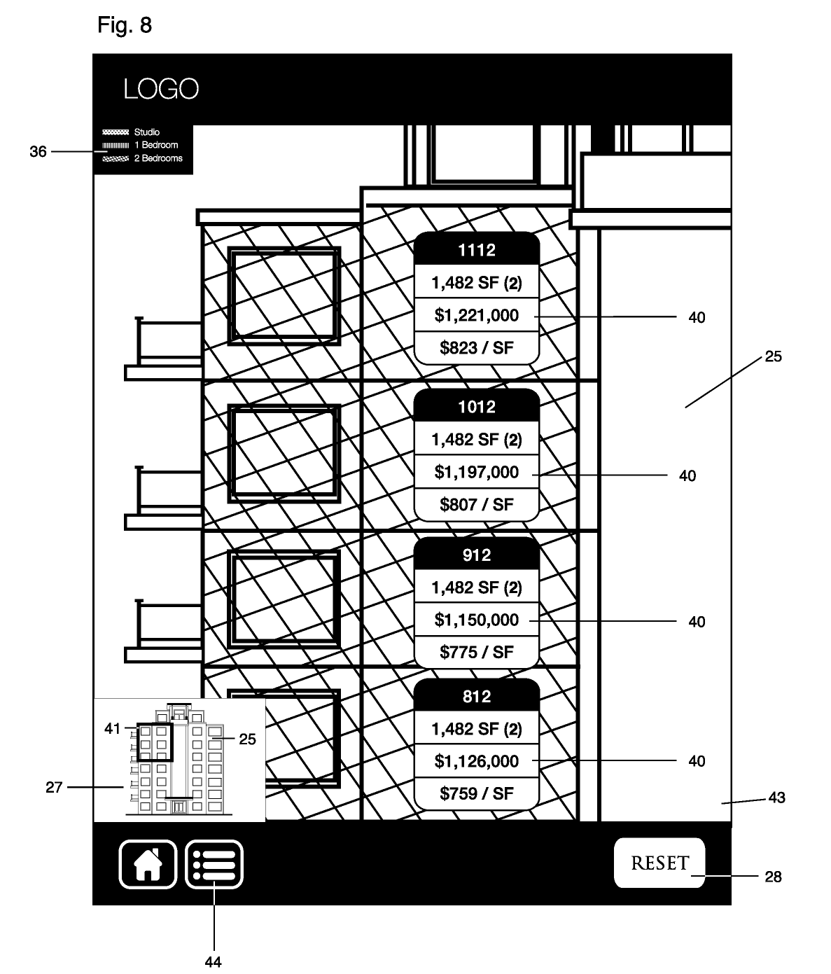

As shown in FIG. 8, in some embodiments, a unit information window 40 showing information about the unit can be displayed merely by zooming in on units. Zooming, panning, and rotation of the viewpoint of the rendering of the three dimensional multi-story building 25 can be accomplished in a variety of ways depending on the implementation. For instance, in embodiments featuring a mouse input device, zooming, panning and rotating the viewpoint of rendering of the building may be accomplished through using the mouse buttons (for example, by allowing the mouse wheel to control zoom, and by panning the viewpoint whenever the right mouse button is pressed and the mouse is moved, and by rotating the viewpoint about the multi-story building whenever the left button is pressed and the mouse is moved, or vice versa). In embodiments using a keyboard input device, a set of keys may be assigned to accomplish each of these tasks. In yet other embodiments, which use a touch screen as input, rotation about the vertical axis of the building may be accomplished via touching the screen and dragging their finger left or right, while panning can be accomplished by the user touching the screen and moving his finger up and down, zooming out can be accomplished by touching the screen with two fingers and pinching them, zooming in can be accomplished by touching the screen with two fingers and dragging them further apart and panning the viewpoint when the user touches the screen, holds his finger down on the screen, and then begins to move his finger, or any other suitable control scheme. In voice operated embodiments, verbal commands can be used to accomplish these tasks without the use of a graphical user interface. In yet other embodiments, controls for moving the viewpoint can be included directly in the graphical user interface (as described in greater detail below). These examples are meant to be instructive, but not limiting, and any manner of rotating, panning or zooming known in the art may be used.

The unit information window 40 may also be displayed in zoomed out views, when a unit is highlighted by the user (such as by mousing over it, or single-tapping the unit it with a touch screen). The unit information window 40 may be displayed within the unit or adjacent to the unit.

FIG. 8 also shows a depiction of the building mini-map 27, which is a smaller rendering of the multi-story building 25 showing the entire view of the building, and having a view box 41, which shows the subsection of the multi-story building 25 that is currently visible in the rendering display area. Additionally, the hide interface toggle button 43 has been used to hide a portion of the graphical user interface 23 in FIG. 8, and can be used again to re-show the hidden portion of the graphical user interface 23. Embodiments of the invention may also include an area mini-map in addition to, or instead of the building mini-map 27, which displays a two dimensional or a zoomed-out, top view of a three dimensional map of the building and its surrounding area. This area mini-map may be placed either in the same window as the building mini-map (where the user may toggle between the two mini maps), in another window such that both mini-maps may be visible at the same time, or on a separate page which can be accessed through the user interface directly, through unit details page or through any other suitable manner. The mini-maps may be provided with a show/hide toggle button that allows a user to toggle whether they are displayed, or in any other suitable location.

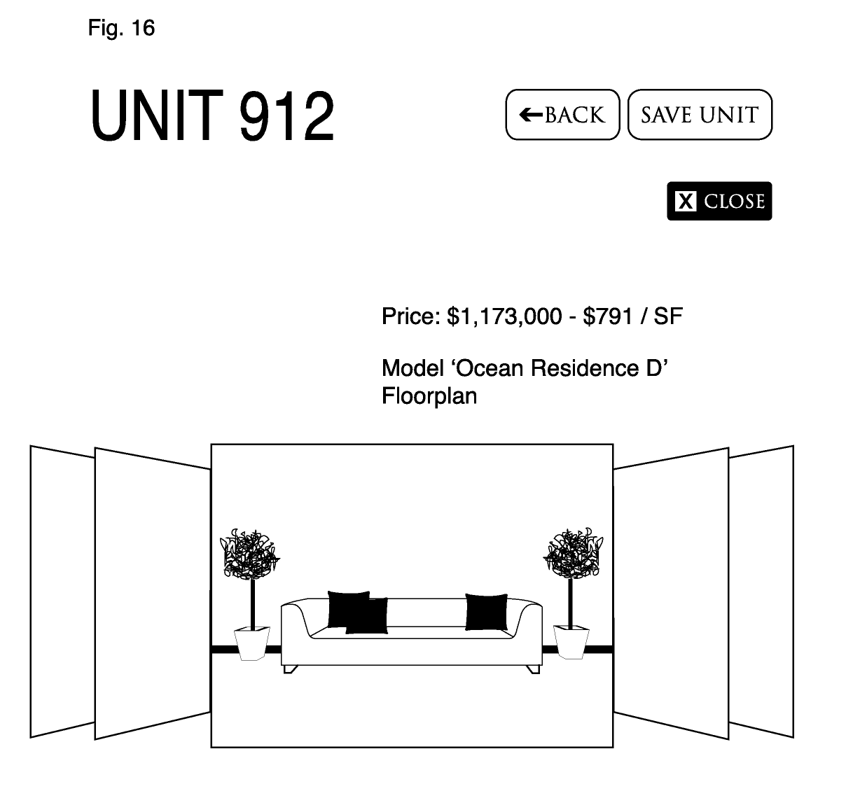

In certain embodiments, as the user zooms in the rendering of the multi-story building may be modified to use a higher polygon count, and/or to display additional features about the building (such as balconies or colors). In other embodiments zooming further into a unit may allow a user to see internal details of the unit, including room layout, default appliances, and other internal features. Software which allows a user to view the interior area of a three dimensional structure, and add or remove furniture, fixtures, etc. has been known in the field for years, and the invention may be implemented to provide such functionality to users. In some embodiments the user can modify the internal structure of the unit to see what options are available. For example, in condominiums that give a purchaser the option of different color kitchen counter-tops or different light fixtures, an embodiment may allow the user to cycle through the different options by clicking on the kitchen counter tops or light fixtures to see what options are available. In still other embodiments the user may be provided with an “Experience the View” or an “Enter the Unit” button, which changes the perspective of the user from being outside the unit, looking in, to being inside looking out. The user can then either be provided with a simulation of the view from the unit, which would require modeling and rendering the surrounding area, or can be directed to the unit detail page (FIG. 14) or the unit picture gallery page (FIG. 16). As described further below, in other embodiments the unit detail page can be reached at any point simply by selecting the unit (through double clicking the unit with a mouse, double tapping the unit on a touch screen, entry of the unit number through the keyboard, or any other method).

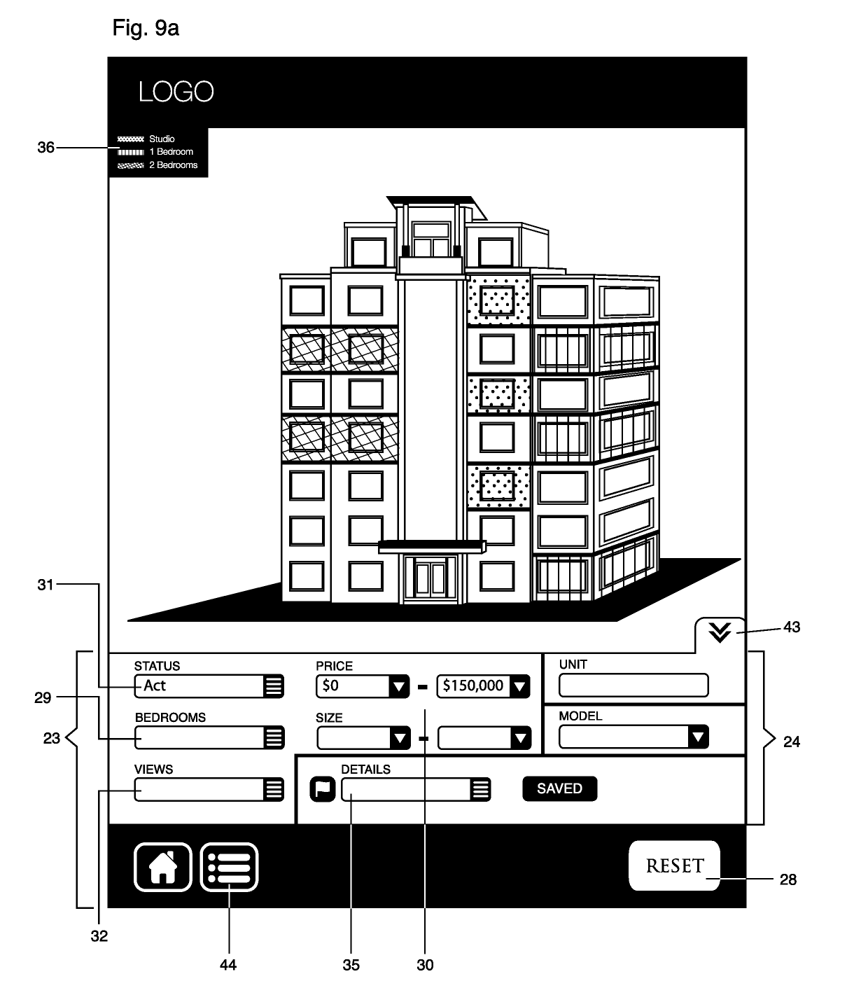

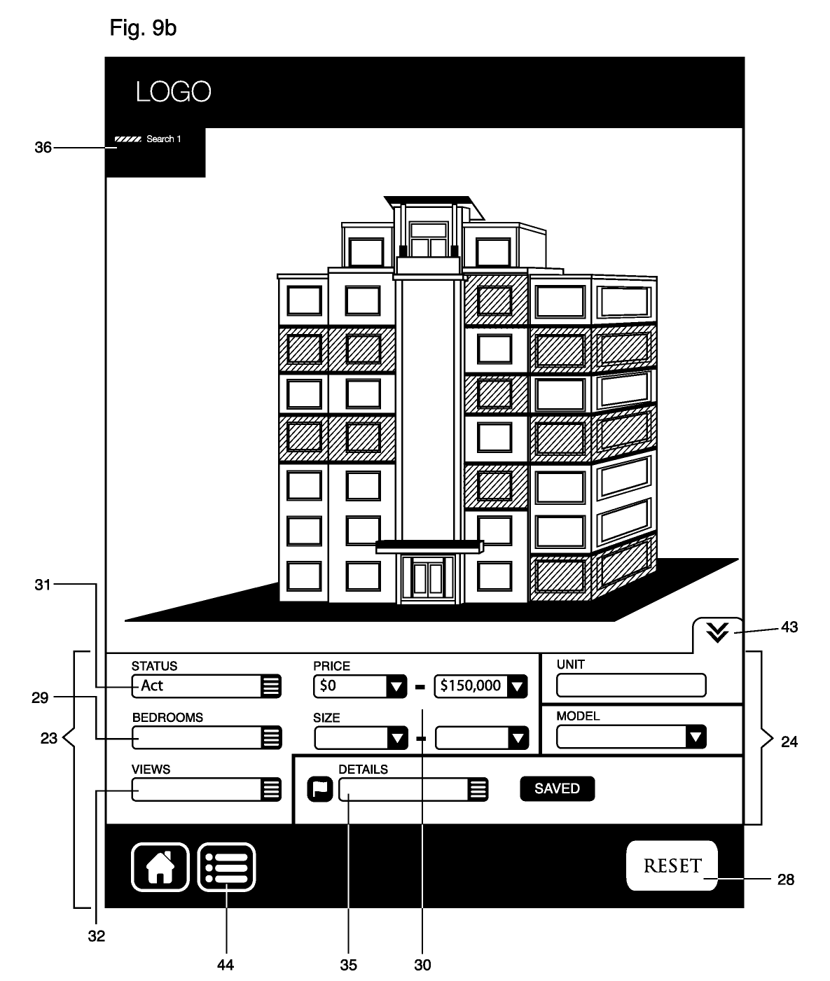

FIGS. 9a and 9b illustrate an exemplary embodiment wherein a search query has been conducted on a database of information regarding the units in the multi-story building 25, and the units meeting the search specified criteria have been graphically marked. Persons of skill in the art will recognize that embodiments of the invention can be implemented to display search results in any suitable manner, as discussed above with respect to graphical marking. In FIGS. 9a and 9b, units have been graphically marked by displaying a pattern over them.

For example, both of FIGS. 9a and 9b, a search has been run to identify units with “ACTIVE” status, and with a price between $0 and $150,000. In FIG. 9a the embodiment of the invention has been configured use different graphical markings for different types of units—studio units are marked with a dotted pattern, one bedroom units with a vertical pattern, and two bedroom units with a slanted pattern. Accordingly, a legend 36 may be included to inform the user what the different styles of graphical marking being used may represent. In contrast in FIG. 9b, all units which meet the search criteria are marked in the same fashion. In such embodiments the legend 36 may merely indicate that a search has been run, or may further indicate the criteria used in the search. Indeed, some embodiments of the invention may allow the user to select whether they want all search results of an individual query to be marked the same way (as in FIG. 9b), or whether they want units with certain features that match the search criteria to be marked in different ways (as in FIG. 9a) and to further customize how those units are graphically marked.

In some embodiments, the units of the multi-story building 25 are graphically marked in real-time, as each search option is selected. This can be accomplished by sending a search query to a database as each option is selected, and updating the display of the viewpoint of the multi-story building 25. In other embodiments the user may select all the desired search options and then submit a search query with the combined search criteria. As described above, the user can select a unit and go to the unit details page for that unit by selecting the unit with a mouse click, by double tapping the unit, or by any other method.

The search options panel 24, allows the user to select search criteria for a search query which can be used to locate units of interest in a multi-level structure. Various sorts of controls can be used to allow a user to select the search criteria. For example, as shown in FIGS. 9a and 9b the search options of minimum and maximum price and size 30 are dropdown boxes, while multiple-selection boxes are used for status 31 and view 32. In certain embodiments, the user can write in the desired limits, or can select from a single range of desired prices/sizes rather than have to independently select maximums and minimums. In some embodiments, in addition to dropdown boxes and/or multiple selection boxes, radio buttons, text boxes, auto-fill text boxes and check boxes may also be used to select search criteria for a search query. In some embodiments a save query button (not shown) may allow the user to save the query and related results for later use.

The user can also select the type of information or details that the user wants displayed by using the details panel 35. As discussed above, this information may be displayed when the user zooms in such that the unit information window 40 fits within or adjacent to the unit(s) (or at a pre-determined threshold level of zoom), or when the unit is highlighted by the user, as by mousing over it, or single tapping the unit on a touch screen.

FIG. 10 discloses an embodiment in which several search queries have been run on the units in the building, and the results of the units meeting each search query are graphically marked in a distinctive manner. In FIG. 10, as shown in the legend 36, units meeting the first search query's criteria are highlighted with a slanting pattern, units meeting the second search query's criteria are highlighted with a dotted pattern, units meeting the third search query's criteria are highlighted with a dashed pattern, and units meeting the fourth search query's criteria are highlighted with a vertical pattern. In color embodiments, each search query could have its results graphically marked in a separate color, and some embodiments may allow the user to select the color other graphical marking method. Units meeting more than one search query's criteria may be graphically marked in a manner which allows the user to visually identify each search query that a unit meets. For example, the highlighting the patterns, colors or icons used to graphically mark a unit could be alternated or combined within the unit. Accordingly these embodiments of the invention allow the user to visually compare different categories of search results simultaneously, while being able to see where the units are in the multi-story building relative to one another.

Other embodiments allow a single search query to generate the results depicted in FIG. 10. For example, an embodiment may allow a user to search for all active, closed, pending and reserved units meeting certain bedroom, price, size and other criteria, and allow the user to specify a different method of graphically marking the active, closed, pending and reserved units that meet the search criteria. Such a search criteria would allow the user to compare similar units with different statuses, and use this information in deciding whether to purchase or rent a unit.

In other embodiments, multiple search queries can be saved, activated or deactivated, and applied as filters, such that the units that are graphically marked as meeting the search criteria are the units which meet the search criteria of each active search query.

In certain embodiments the user also has the ability to zoom in on a portion of the multi-story building, which can bring up additional information, such as the unit information window 40, about the units in the zoomed-in display, similar to what is shown in FIG. 8. In certain embodiments only graphically marked units meeting search query criteria may display such information. In other embodiments all units visible may display such information. In yet other embodiments a user can select whether to see information about all units or graphically marked units only.

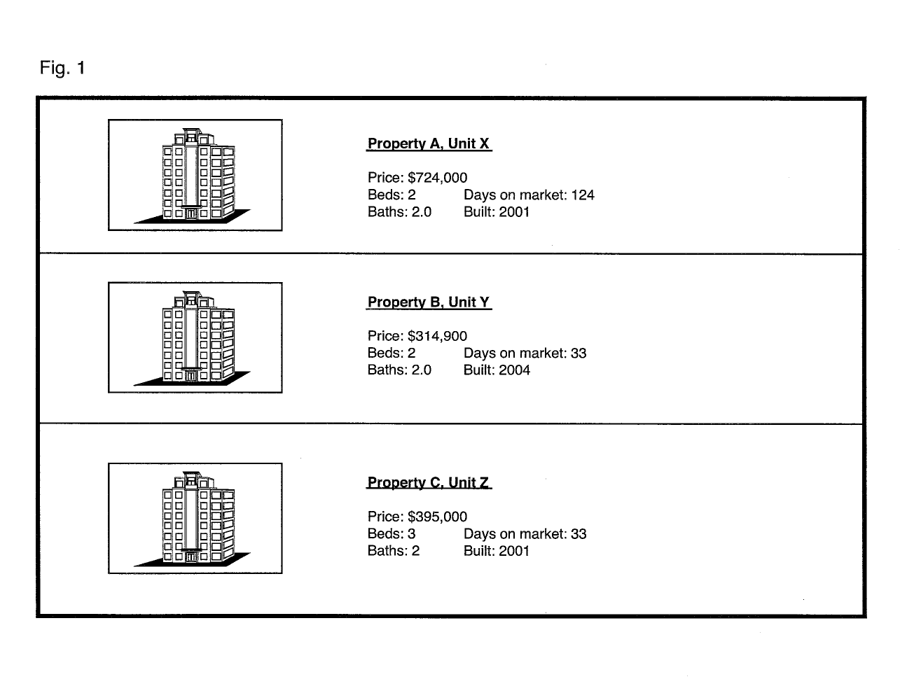

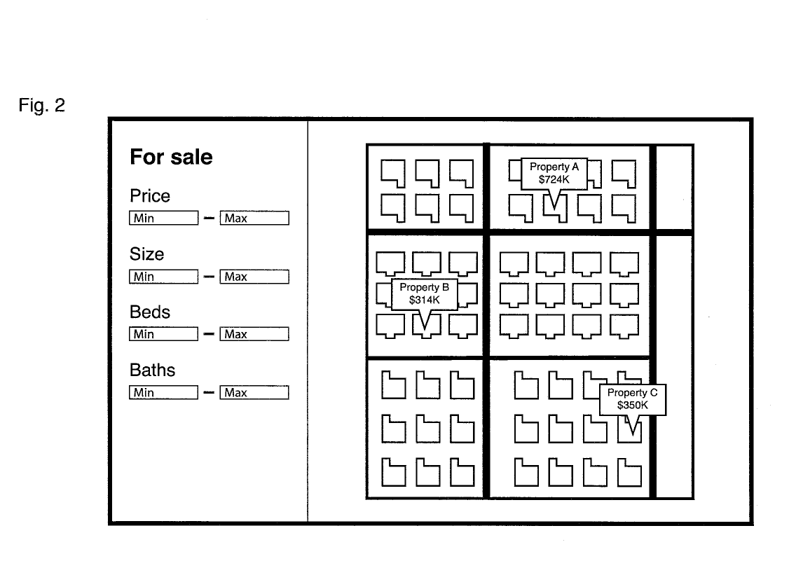

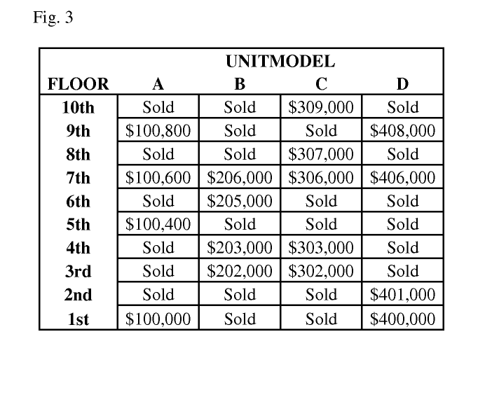

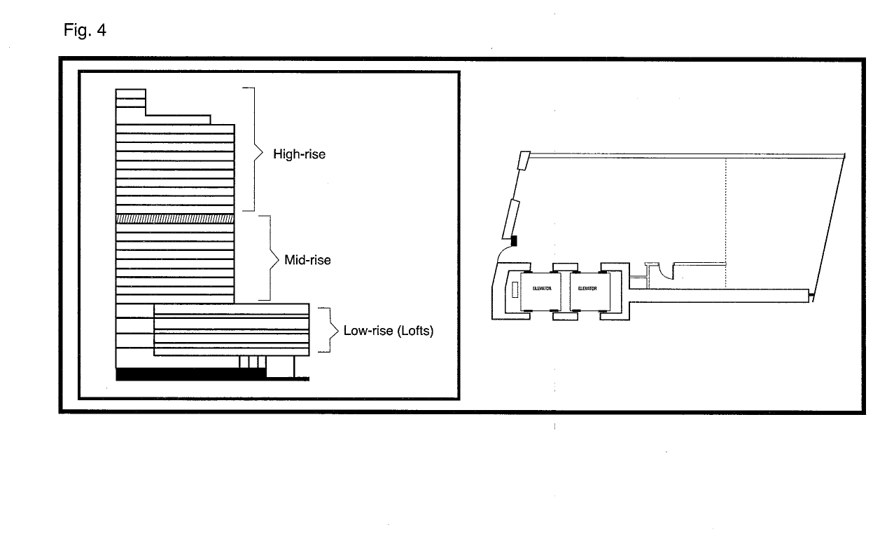

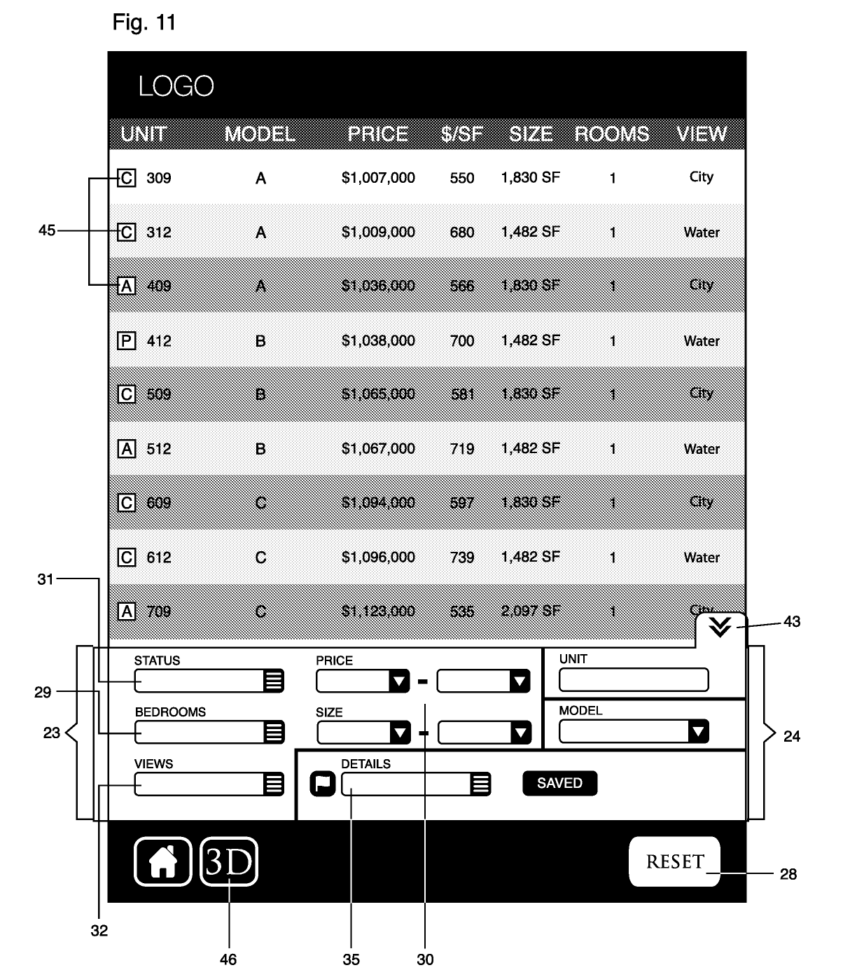

FIG. 11 illustrates an embodiment having a list view page that can be accessed by using the list view button 44. In this view, a user can view the search results in list fashion similar to the prior art list shown in FIG. 1. The list view page may replace the three dimensional page, or it may be displayed as a pop-up or split-view window, over or to the side of the 3 dimensional rendering, or in any other fashion. Information about units is presented in rows 45, which contain the unit identifier and other information related to each unit. As shown in FIG. 11, in certain embodiments, the list view may also display the graphical user interface 23, including the search panel 24 allows the user to run search queries and select the types of information the user wants displayed for each unit. Additionally the reset button 28 may be provided to clear any active search queries and the interface toggle button 34 may be provided to toggle the display of all, or part of, the graphical user interface 23. As in the three-dimensional page, a user can select a unit by clicking a mouse button on a row, or by tapping or double tapping the row on a touch screen, or any other such method. When a user selects a unit, the embodiment may bring up the unit details page. In list view, the graphical user interface 23 also may provide a “3D” button 46, which closes the list view and returns the user to the rendering display area 22.

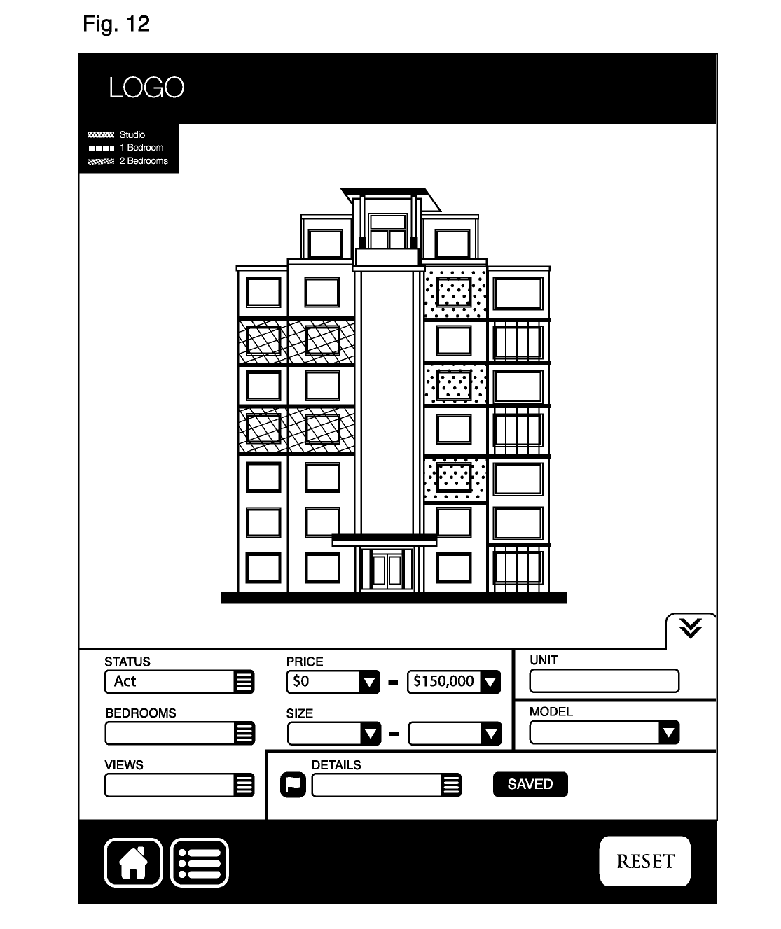

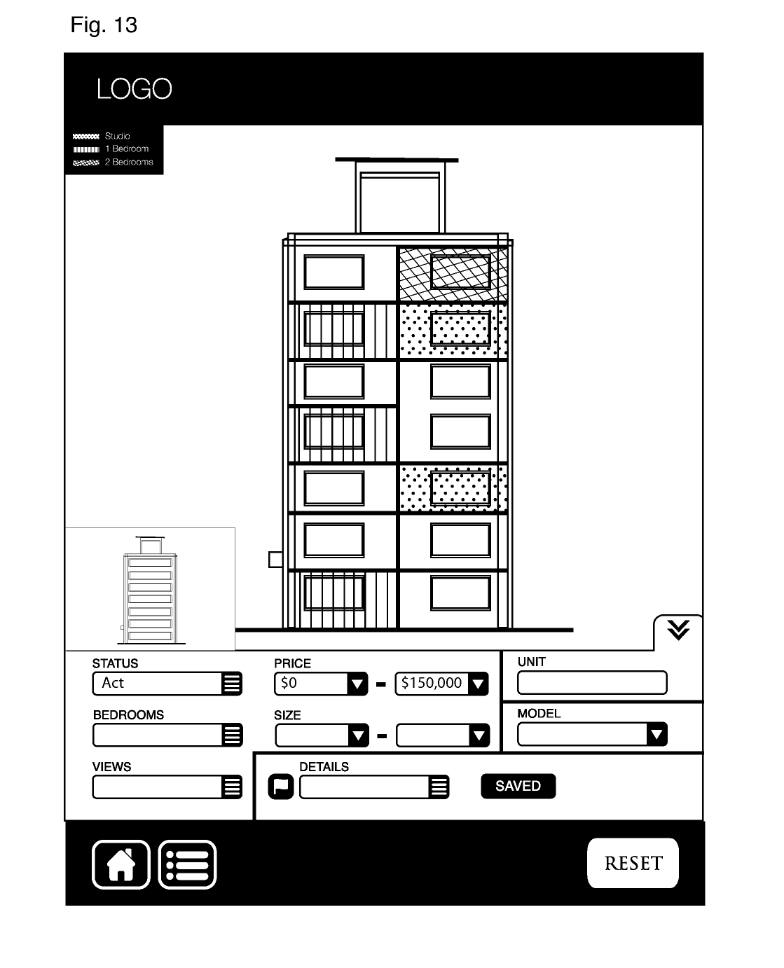

The user's ability to rotate and pan the viewpoint of the rendering of the multi-story building 25 in order to change the perspective and portions of the multi-story building 25 displayed in the rendering display area 22, enables the user to gain visual perspective regarding the spatial relationships between units in the building 25. However, no matter how intuitive and simple the controls for managing the view are made, some users (particularly new users) may find manipulating viewpoint to be a difficult task. Accordingly, some embodiments may come with pre arranged viewpoints that a user can select in order to gain different perspectives of the rendering of the multi-story building. For example, FIGS. 12 and 13 show a front and side view point of the multi-story building 25 with the same query run on it as shown in FIG. 9a. A person of skill in the art will recognize that a variety of pre-arranged viewpoints can be selected to showcase various aspects of the multi-story building, including its various facets and amenities (pools tennis courts, etc.). Controls allowing the user to select which pre-arranged viewpoint a user would like to use can be implemented in a variety of ways, including adding a viewpoint dropdown box to the graphical user interface 23, or adding controls to the graphical user interface 23 which allow the user to cycle through the pre-arranged viewpoints or choose a specific pre-arranged viewpoint.

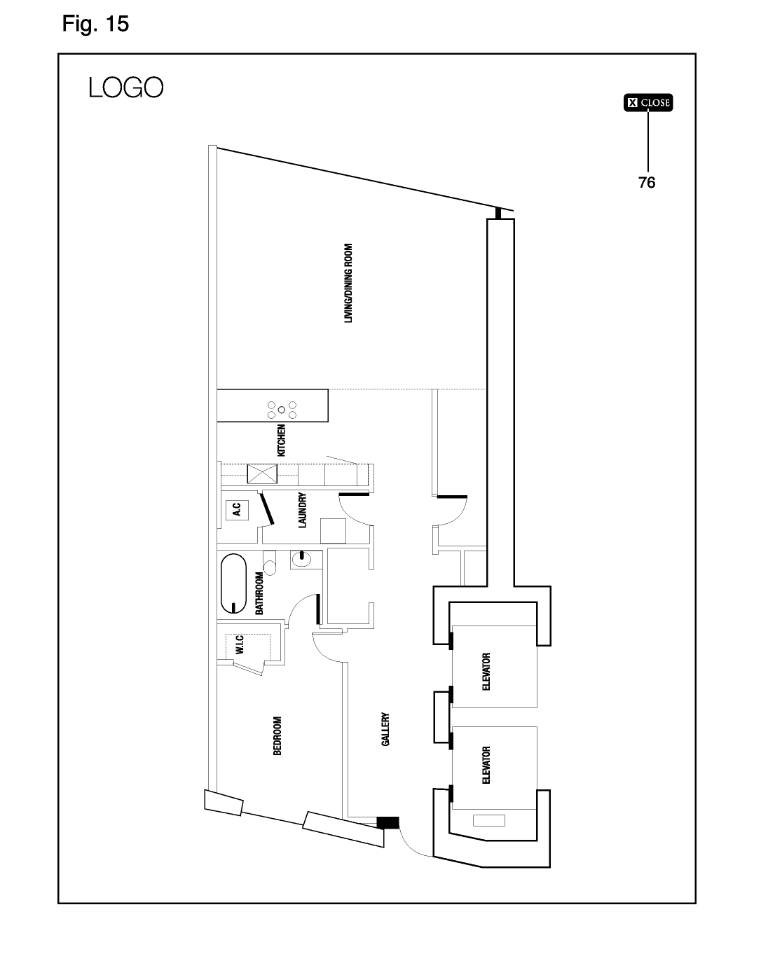

FIG. 14 illustrates a unit details page that may be included for each unit in certain embodiments, and which may be organized in a variety of fashions, at the implementer's discretion. The unit details page may provide additional information about the unit, including without limitation, unit price, price per square foot, model type, number of bedrooms, number of bathrooms, the size of the unit, a more detailed description of the unit, a description of the view from the unit, pictures of the unit, the floor plan of the unit, the floor plan of the floor of the building the unit is on, a 3 dimensional rendering of the unit interior, the number of parking spaces or storage units the unit has, etc. The unit page may further link to additional pages, such as a floor plan page (FIG. 15) or a unit picture gallery page (FIG. 16), etc. The unit details page in FIG. 14 provides links to two image galleries, one being a gallery of images of the unit itself 61, and the other being a gallery of the views from the unit 62. The unit details page in FIG. 14 also provides a link to a floor plan page 60. The unit details page may also be provided with a “Back” button 64, which returns the user to the page from which the user had navigated to the unit details page.

The unit details page may also be provided with a “Save Unit” button 63, which saves the unit for later evaluation or comparison to other units for the user. Units that are saved may be retrieved for viewing at a later time by the user, for example by using a “Saved Units” button on the graphical user interface, by accessing a saved units page, or any other such method. The saved units can be listed, as in the list view page, or can be graphically marked on the three-dimensional rendering of the multi-level building 25 on the rendering page. Saved units may be stored locally on the machine running or accessing the embodiment of the invention, or may be stored on another computer device (for example on the computing device running the master database).

FIG. 15 illustrates a unit floor plan page that may be included in certain embodiments of the invention, which may provide the user with the floor plan of the selected unit. The unit floor plan page may also provide information regarding the model number, size of unit, number of bedrooms, number of bathrooms, etc. Additionally, the unit floor plan page may also provide the floor plan of the floor of the building that the unit is on. The unit floor plan page may further be provided with a “Back” button 64, which returns the user to the page from which the user navigated to the unit floor plan page. In other embodiments, the unit floor plan page may be implemented as a pop-up window, as a sub-part of the unit details page that takes focus away from the remainder of the page, or in any other manner known in the art. In such embodiments, the unit floor plan page may be provided with a “Close” button 70, which closes the unit floor plan page and returns focus to the window having the page from which the user navigated to the unit floor plan window.

FIG. 16 illustrates a unit picture gallery page included in certain embodiments of the invention, which may include a series of pictures related to the unit. The unit picture gallery page may include photographs of the interior of the unit, the appliances, the views from the unit, the amenities of the building, etc. As with the unit floor plan page, the unit picture gallery page may include certain basic information about the unit. The unit picture gallery page may also be implemented as a popup window, or as a sub-part of the unit details page that takes focus away from the remainder of the page, or in any other manner known in the art. Accordingly, the unit picture gallery page may be provided with a “Back” button 64 or a “Close” button 70, as needed, which returns the user to the page from which the user navigated to the unit picture gallery page.

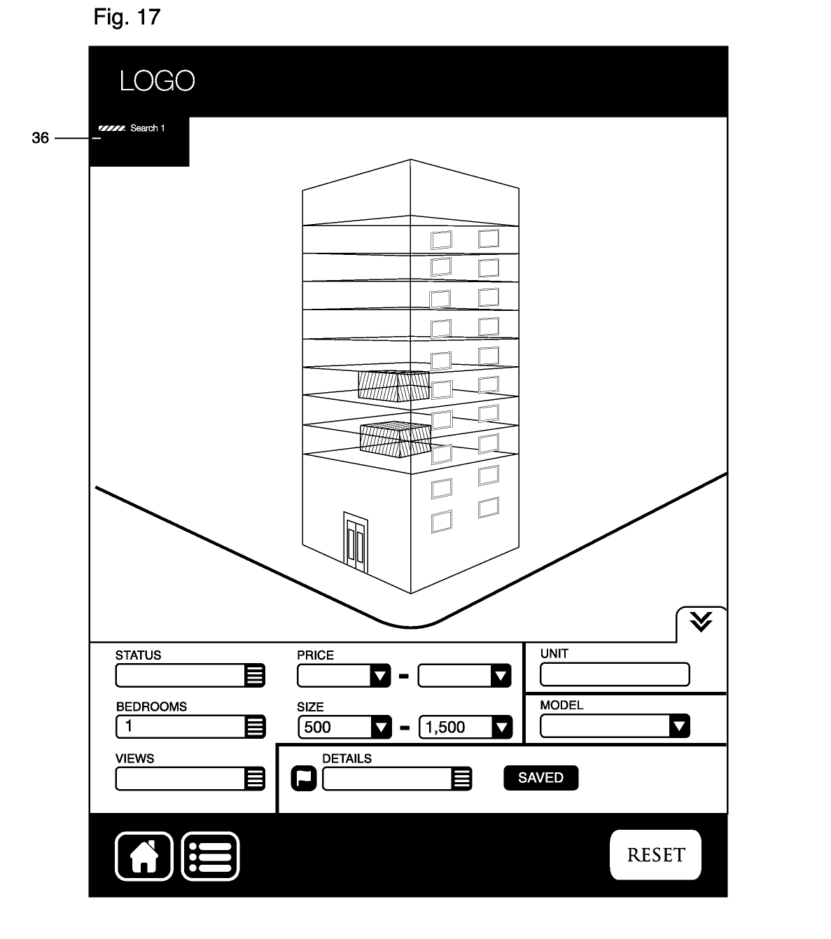

FIG. 17 illustrates how an internal unit in the multi-story building—a unit that does not touch any of the outer walls of the building—may be displayed. Whenever an internal unit meets search criteria, or whenever a building has internal units, the outer units may be drawn or rendered as partially transparent or translucent, such that the interior units are visible. To allow internal units to be selected or highlighted, each internal unit may be given a “hot spot” that may be smaller than the its entire rendering area, and that can be clicked on or tapped through any intervening outer unit.

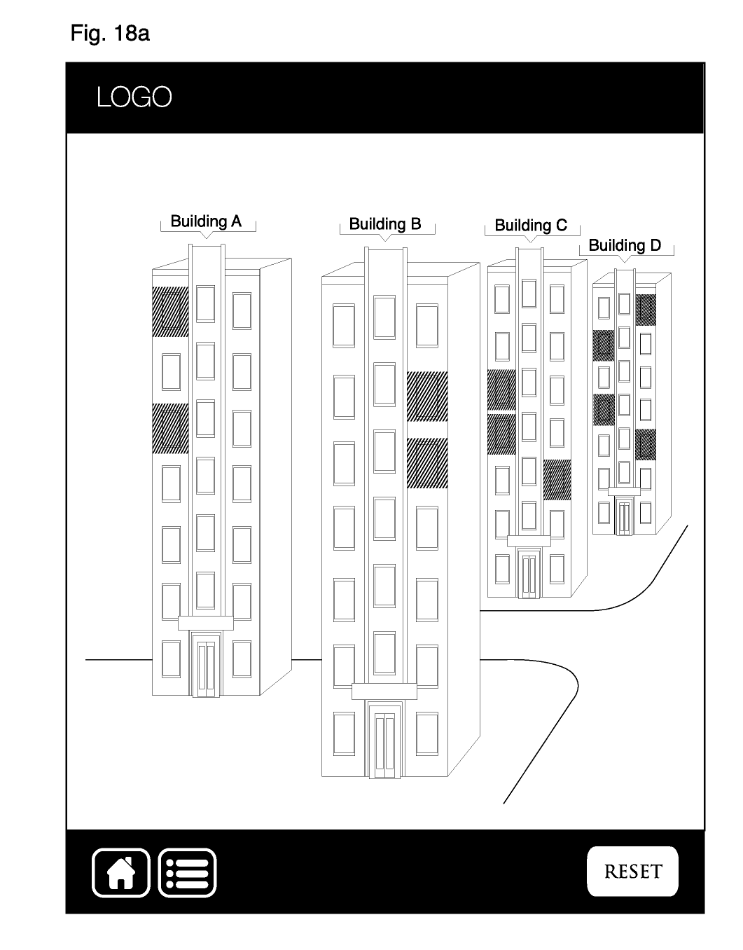

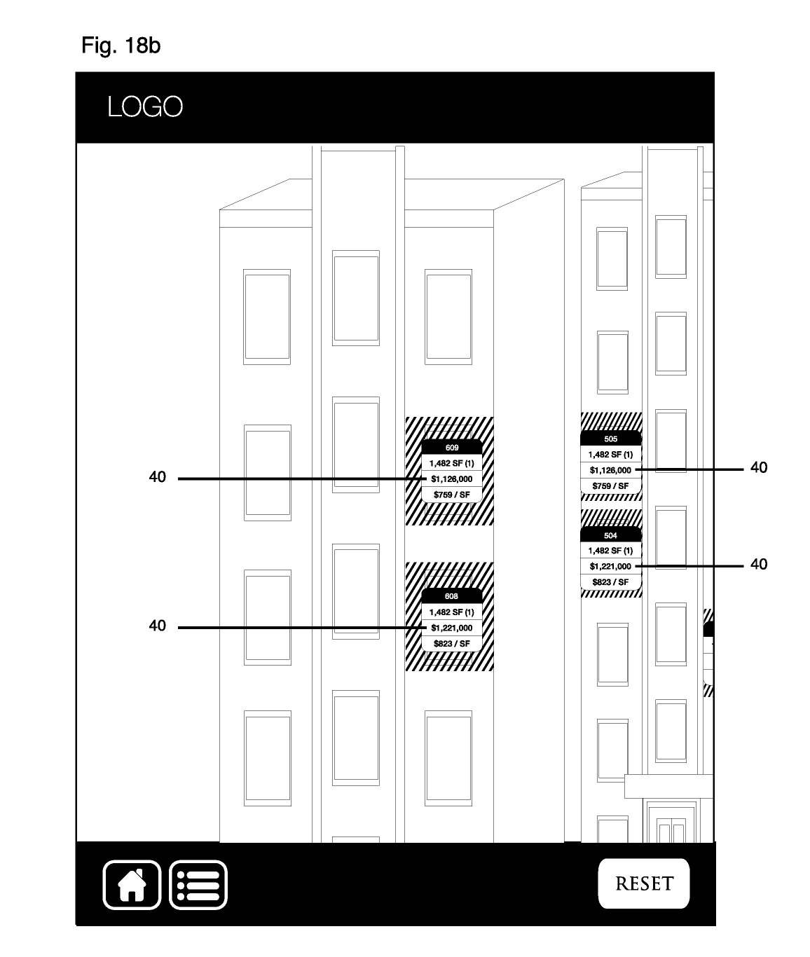

FIGS. 18a and 18b illustrate an embodiment of the invention wherein multiple multi-story buildings are displayed and may be searched. The multiple buildings may be part of the same complex, in the same geographical area, or may simply be separate buildings that the user wants to search. Embodiments like the one shown in FIGS. 18a and 18b may allow the user the same functionality previously, with the added benefit that the user can see and search multiple buildings simultaneously, while (if the buildings are organized according to scale and their real-life locations) gaining a perspective of the spatial relationships between the units of the various buildings. In embodiments of the invention allowing searching of multiple buildings, additional search criteria may be included in the search panel to allow users to compare features of the different buildings which may be independent of the unit. Some examples of the types of features which may be included are, building amenities, building size and height, date of construction, type of construction, building policies (whether pets allowed, etc.), etc. FIG. 18a shows an embodiment wherein units in four multi-story buildings may be simultaneously searched, and search results showing units meeting the search results in multiple buildings. FIG. 18b shows a “zoomed in” view point of the rendering of the multi-story buildings wherein additional information is displayed about the units that have been graphically marked. In addition to information about the units, aggregate information for each of the buildings may be displayed, such as the number of sales within a certain period of time, average prices, change in pricing, etc. This information may be displayed in any suitable fashion, including within the viewpoint of the rendering (over, partially over, adjacent to the building, connected to the building by a line or arrow, on a separate window, page or pane, or in any other suitable manner). Persons of skill in the art will recognize that embodiments such as the one depicted in FIGS. 18a and 18b can include any of the functionality described above.

It is worth noting that while the above descriptions generally discuss the use of certain input devices, such as a keyboard, mouse or touch screen, the invention can be practiced with any input devices known in the art for computing devices, including without limitation, joysticks, game pads, voice commands and other audio input, video input processing (e.g. using a camera) and motion recognition devices (such as Microsoft Kinect), accelerometers, or any combination thereof. Persons of skill in the art will recognize the types of design choices that may be made to adapt an embodiment of the invention to work with any one or more of such input devices. Indeed, depending on the types of input an embodiment is implemented to handle, the graphical user interface may become unnecessary and optional, and a non-graphical user interface may be used, such as a voice controlled user interface.

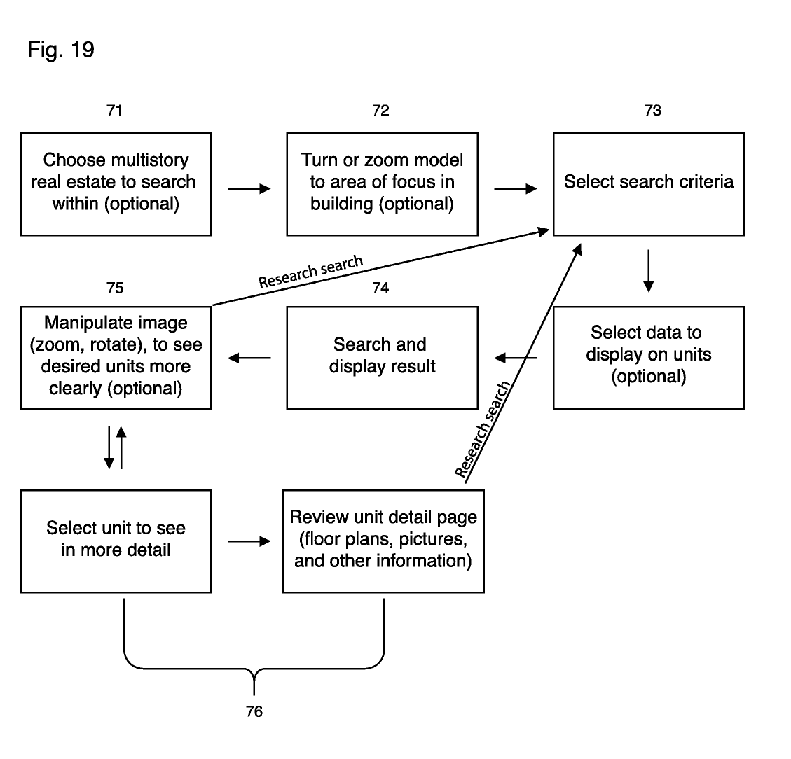

FIG. 19 illustrates one possible method embodiment of the invention relating to the real estate marketplace. Persons of skill in the art will recognize that this is an illustrative example of the method of the invention, and should not be considered limiting in any way. The first step in FIG. 19, which allows a user to choose the multi-story building to be searched or displayed is optional, as some embodiments may be designed to search a specific building, while others may allow multiple buildings to be searched. In some embodiments, this can be achieved through defining areas on a two dimensional map, specifying location through entering city, state, zip, neighborhood, county or otherwise, or orienting the camera in 3D space to properly focus on the region desired, or in any other suitable manner.

In the next step 72, the user may optionally select a desired viewpoint of the multi-story building(s) 25, by rotating, zooming and panning to the desired viewpoint or by selecting one of the pre-arranged viewpoints. Alternatively the user can skip this step and proceed with the default viewpoint.

The following step 73 involves selecting search criteria and/or selecting the types of data to display about the units.

The search and display results step 74 begins when the user has selected the desired search criteria and submits the criteria. A search query is created and passed along to a database, which will return results. The results are then used to modify the three dimensional surface of the various units such that units that meet the search criteria are graphically marked in any of the ways described above.

At any point the user can refine the search criteria or the data to be displayed about the units, which may or may not require another search query to be transmitted to the database. In some embodiments, as described above, additional search queries can be simultaneously run and displayed, or search queries can be combined to show only units that meet the criteria in all of the combined search queries.

Once the results are displayed the user may optionally manipulate the view point in step 75, either by manual rotation, panning or zooming, or through any pre-arranged viewpoints, to see the units from various perspectives.

The user may then select a unit of interest 76, and be presented with a unit details page, as described above, wherein the user may see additional information about the unit, review floor plans, see picture galleries and select to save the unit for later review. The user can then return to browsing the graphically marked units that satisfy his earlier search criteria, or proceed to refine the search, or start a new one.

It will be well understood by persons of skill in the art that the above-description is one of many different embodiments of the method of the invention. Some embodiments of the invention need not provide search functionality, and may merely display information about the units as a user manipulates the viewpoint. Other embodiments may have some or all of the features described above with respect to FIGS. 6-18, and may even have additional features.

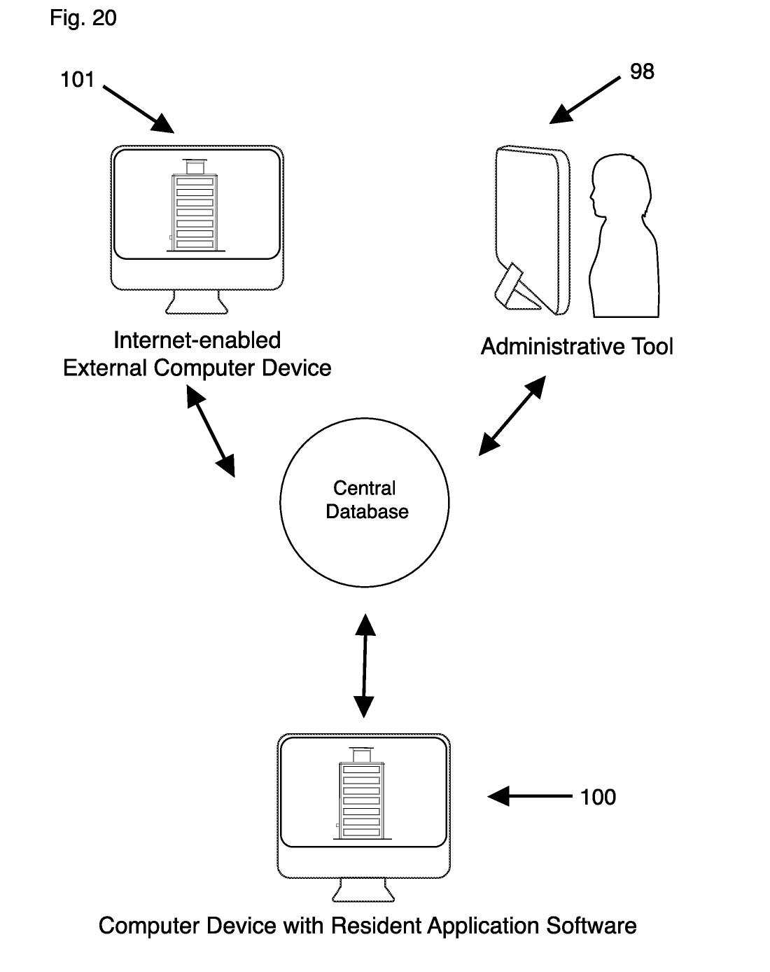

FIG. 20 illustrates one system embodiment of the invention. A master database 99 maintains information about the multi-level structure(s), to be displayed or searched, and their respective units. The database may, but need actually not be centralized, and can be any sort of database capable of maintaining such information, including a distributed or relational database, any commercial database, including Oracle, SQL, MySQL, SQLite, etc., a proprietary database, etc. The database may be housed on any adequate type of computing device, including without limitation, servers, personal computers, notebooks, PDAs, touch pads, smart phones, other multi-function devices, etc. In some embodiments the database may also keep and make accessible the multi-level structure's model, and any associated marking overlay pertaining to the respective units either directly or keeping and providing links to such files.

In some embodiments of the invention, an existing database containing information about the units of the multi-level structure, or multi-story building can be converted into a master database for the invention, by adding to each unit record a field for associated three-dimensional model files, and filling that field with the marking overlay file for the unit or other volumetric information about the unit and its location within the building, and/or the building model file, or with a link to such file(s). In some such embodiments, a field for the building model file can be added to a record containing information about the building generally (i.e. not about the individual units).

The database may be managed by an administrative tool 98, through which an administrator can update the information about the units. The administrative tool 98 may reside on the same machine as the master database 99, or may be on a different machine that can access the database either locally, or remotely (via a network or the internet). Accordingly, an administrator can access the administrative tool directly or remotely using a web browser, VPN connection or some other such method.

Computing devices with a resident software application 100 may access the master database 99. These computing devices may have a computer program product embodiment of the invention installed thereon. These computing devices may receive from the database information regarding a multi-level structure its units, and display such information graphically in the manner described above. Additionally, these computing devices 100 may send the database search queries and receive from the database result lists which can then be used to graphically mark the units and display the search results in the manner described above. The computing device embodiments of the invention may include an input device of any of the types of input devices described above, including without limitation: keyboard, pointing device (such as a mouse, trackball, touch screen, multi-touch input device), microphone, joystick, game pad, satellite dish, scanner, movement sensor device such as the Microsoft Kinect or the like. The computing device may also include a display device, including without limitation, a monitor (CRT, LCD, plasma, OLED, etc.), a touch screen, a projection device, holographic displays and other 3D display devices, and any other suitable display devices.

It is worth noting that in some embodiments, the master database 99 (and indeed also the administrative tool 98) may reside on the computing device with resident application software 100. Alternatively in other embodiments, the computing device 100 and the master database 99 may be independent. In some of these embodiments the computing device 100 may access the database each time it needs to run a search query, or otherwise needs information from the master database 99. In other such embodiments, the computing device 100 may maintain a local database, which has a copy of the information present in the master database 99. Accordingly, the computing device 100 may operate in the manner described above to render the multi-level structure, and display information about and/or allow searching of the units independently of the master database. In such embodiments, the computing device 100 may periodically connect to the master database 99 in order to update its local database with any information that may have changed. A resident software application may be installed on a computing device by any method, including without limitation, downloading the application via the Internet or from a network, installation by disk, installation through a wired or wireless connection to another computing device, etc. Certain computing devices may require specific or limited methods of installation, while other may allow more freedom in installation methods. For example an Apple iPad or iPhone, for example, may require installation through the Apple Store or through iTunes running on a paired computer.

Another type of device which may be used with a system embodiment of the invention is an Internet-enabled external computing device 101. Unlike the computing device with the resident application software 100, the Internet-enabled external computing device 101 does not independently have a computer program embodiment of the invention installed therein, and cannot independently practice the invention. Instead the Internet-enabled device 101 connects to the database via the internet, for example by means of a web-based application that may be loaded by the Internet-enabled device 101. The web based application may be loaded from a web server that may or may not be independent from the master database 99, and as with the resident application software, displays a viewpoint of the three dimensional multi-level structure and its units, and may display information about the units and/or allow searching of the units and graphically mark the units that meet search criteria, in any of the manners described above.

Both the Internet-enabled external computing device 101 and the computing device with resident application software 100 may be any type of computing device, including without limitation, personal computer, laptop, notebook, tablet computer, personal digital assistants, touch pads, multi-touch devices, smart phones, other multi-function devices, stand-alone kiosks, computer terminals, etc.

Persons of skill in the art will recognize that the description and structures shown in FIG. 20 are exemplary, and that a system embodiment of the invention need not have each recited structure. For example an embodiment need not accommodate both Internet-enabled external computing devices 101 and computing devices with resident application software 100, and need not require an administrative tool 98, as the master database 99 can be updated and maintained without such a tool.

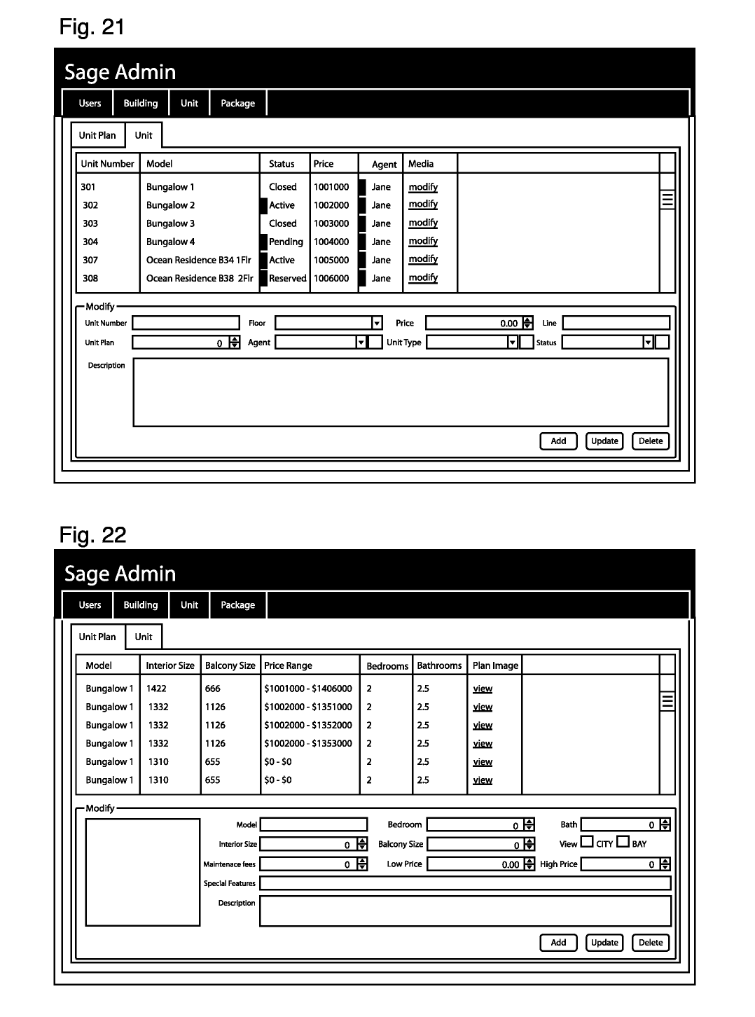

FIGS. 21 and 22 illustrate possible implementations of the administrative tool of certain embodiments of the invention. FIG. 21 shows the unit information page of the administrative tool, wherein each unit is displayed on a row, and can be selected to have the unit's information displayed more fully below in the information modification area 95. The administrator can then use the information modification area to revise or update the units information, or to delete or add the units from and to the database, for example by using the respective buttons shown in FIG. 21. The unit page may include fields for the unit number, model number (or unit plan), its status, price, any agent assigned to it, any files associated with it (floor plan, pictures, etc.), a description, and any other field that is kept in the database. The use of the unit page is not the only manner in which the database can be populated, as information can be imported from spreadsheets, other databases, or coded manually into the database.

FIG. 22 illustrates the unit plan page, which can be helpful in embodiments of the invention wherein the multi-level structure has a series of identical units which follow one or more model or unit plan. Through the use of this page, each unit plan or model is listed in its own row 91, and as with the unit page, information relating to the unit plan can be updated, added or deleted in the unit plan information modification area 90, for example by using the respective buttons shown in FIG. 22. The type of information that is common to units sharing the same unit plan may include the model name, number of bedrooms and bathrooms, the interior size, and balcony size, if any, maintenance/HoA fees, low and high price points for the unit plan, special features and the description. Accordingly, when a unit is entered on the unit page and a unit plan is selected for the unit, the information on file for the unit plan may automatically be filled in for the individual unit, or may be accessed through the entry for the unit plan.

Persons of skill in the art will recognize how the administrative tools 98 may vary, and the design choices that would be made depending on the type of multi-level structure an embodiment of the invention is designed to deal with. For example hotel embodiments may need fields in the unit page to have fields for the number and type of beds in a room, the amenities in the room, etc., while ship embodiments may require the unit page to have fields for the number and type of bunks or beds in a cabin, and building maintenance or security embodiments may contain fields in the unit page for maintenance appointment, power and water usage, and sensor data, and so on. In addition to (or in lieu of) the administrative tool 98, the master database 99 may be updated directly, such as by being linked to a multi-level structure's internal management software (MRI, JD Edwards, etc.), the Multiple Listings Service (MLS) databases, or other listing services (loopnet.com, CoStar, Zillow.com, Rent.com), inventory management systems such as commonly found for hotels and condo sales, or any other internal or external information source. The administrative tool 98 can be developed using any development platform (Visual studio, Silverlight, PHP, etc.), or other suitable coding method.

The device embodiments of the invention may include what has been described in the system embodiment above as computing devices with a resident software application 100 or Internet-enabled external computer devices 101. These devices are capable of displaying a viewpoint of a three dimensional rendering of a multi-level structures having a plurality of units, and displaying information about such units and/or allowing the units to be searched and graphically marking units that meet the search criteria as described above.

The descriptions above have primarily focused on the residential condo real estate marketplace. Embodiments of the invention may also be implemented for other real estate uses. For example, the invention could be implemented for the residential real estate rental market, in the same manner described above, except that rent rather than price would be used, and additional information might be displayed or made into a search option (such as minimum rental term, maximum rental term, whether the unit is furnished, pet policies, whether a security deposit, last month's rent or both are required to move in, etc.). For the hospitality industry (hotels, resorts, etc.) an embodiment of the invention may be implemented to facilitate the booking of rooms. The “unit” may be the rooms, suites, etc., and the information that is displayed about the units or that may be searched may include the number of beds, amenities (kitchen, refrigerator, whirlpool tub, etc.), and dates of availability. Alternatively, for the hospitality industry, an embodiment of the invention may facilitate the leasing and booking of entertainment, conference or meeting with a hotel, conference center or the like. In this embodiment, the “unit” might be meetings rooms or conference centers and the information that is displayed might be price, capacity, availability dates, amenities, etc. Multi-story commercial real estate building (office buildings, malls, industrial buildings, self-storage buildings, etc.) may have embodiments where the units are spaces within the building, and the information that is displayed or searchable includes the size of the space, the rental price, lease term, condition of the space, etc. Universities may use embodiments of the information for their dormitories, classrooms and research lab spaces. Convention centers and hotels may use embodiments of the invention to assist with the allocation of convention halls, convention stalls, ballrooms, etc. Multi-story factories and warehouses might use an embodiment of the invention to allocate space to various customers, or to track where materials or inventory is kept.

In addition to these uses, embodiments of the invention may be used for building management, maintenance and security. A condominium or apartment building can use an embodiment of the invention to monitor which units are maintenance schedules for units, what units work has been done in, power and water usage in each unit, power usage, water usage, sprinkler status, smoke detector status, appliance status, utility payment, utility delinquency, rent payment, rent delinquency, association fee payment association fee delinquency and maintenance appointments, utility payment delinquencies, unit owner, historical sales information, loan information, property taxes, etc. A hospital, for instance, could use an embodiment of the invention to monitor the amount of available patient rooms, maintain information about the equipment in each room, and even on the conditions of the patients. A large corporate complex might use an embodiment of the invention to monitor employee distribution, team distribution, maintenance schedules tools or computing devices in offices and cubicles, power usage by unit, etc. Embodiments of the invention can be integrated with security sensors, and keep track in real time of any security risks (activated motion sensors or smoke detectors, or unlocked windows or doors, unauthorized entry attempts, etc.).

Outside of the real estate industry, embodiments of the invention may be implemented for large vehicles, such as cruise ships, passenger ships, or naval vessels. Such embodiments can be used for the allocation of cabins, and display information about the cabins (type of cabin, size, number and type of beds/bunks, etc.) and/or allow that information to be searched. Alternatively, embodiments of the invention can be made to manage and maintain such vessels, and keep track of personnel, unit status, maintenance histories and/or schedules, etc. As with the security embodiments, such embodiments for managing vessels may be integrated with sensors throughout the vessel to provide a real-time status about the vessels' units. Other embodiments can include=jail cells within a penitentiary, storage units in a self-storage building, or any other unit of space within a multi-level structure.

Any of the embodiments of the invention can be included as part of an existing website for a building or ship, or a more general website, such as a general travel/hotel booking website. Such embodiments could store and track user information, either on the user's machine through cookies and the like, or on the web server, and store save units, search histories, etc. Embodiments may also include maps of the area surrounding the multi-level structure, including tourist attractions, landmarks, restaurants, hotels, schools, and other locations of interest. Embodiments of the invention may also be included as part of a greater, broader application, such as a hotel's internal IT or room information system, security software for monitoring a building, condominium management software, etc.

Another field where embodiments of the invention may be implemented is augmented reality. In such embodiments, in place of a three-dimensional rendering of a multi-level structure, a snapshot, or video feed is taken by a computing device, such as a laptop, notebook, touch pads, multi-touch devices, smart phones, etc. having a camera, or other multi-function devices. The image is processed using known image recognition techniques in order to identify the multi-level structure. Such known techniques include, without limitation, edge detection, Scale-invariant Feature Transform (SIFT), template matching, gradient histograms, intra-class transfer learning, explicit and implicit 3D object models, global scene representations, shading, reflectance, texture, grammars, topic models, window-based detection, 3D cues, context, leveraging Internet data, unsupervised learning and fast indexing. Location information, if available from the computing device, may be used to facilitate the identification of the multi-level structure. The identification of the building can be performed by the computing device itself, or can be performed by other computing resources connected to the computing device via a network or the Internet. Alternatively the user can manually (or by voice) identify the multi-level structure. A discussion of object-identification techniques which can be used with the invention can be found in U.S. Publication No. 2011/0164163, published Jul. 7, 2011, which is incorporated herein by reference in its entirety.

Once the multi-level structure is identified, the viewpoint to the multi-level structure may be computed using the information from the snapshot or live video feed. In other words, by comparing features of the multi-level structure presented in the snapshot or live video feed to three-dimensional model of the multi-level structure, the position of the user relative to the building can be calculated using known image processing techniques, such as line and edge detection algorithms, template matching, etc. For instance, if the snapshot or video feed shows a corner of the multi-level structure, the line that extends along the corner of the multi-level structure, as well as other lines that are visible on the structure, can be calculated through the use of known line and edge detection algorithms. The three-dimensional model of the multi-level structure can be rotated such that each of its corner lines is aligned with the corner line from the structure. Through a combination of one or more of (1) comparing the other visible lines in the snapshot or live video feed to the lines visible on the model (such as by comparing their relative slopes), (2) scaling the model to different sizes, and (3) template matching or best-fit matching, the viewpoint to a three-dimensional rendering of the multi-level structure which matches the user's actual viewpoint to the multi-level structure can be calculated. As with the identification step, the calculations for this step can be performed by the computing device or by other computing resources connected to the computing device by network or the Internet.

Treating the live feed or snapshot as the rendering of a three-dimensional model, the user can then seek information about units in the multi-level structure, and run search queries and have the results graphically displayed through overlays on the snap shot or live video feed. In embodiments using a live video feed, when the user moves, the video image changes, and the relative change to the viewpoint can be calculated and applied. In computing devices that contain accelerometers and other motion sensors, data from such devices can also be used to assist with these calculations. In this manner a user may take a live video feed of a condo he is interested in, and use an embodiment of the invention to learn information about different units, search for units that meet certain criteria as described above, and save all units that he is interested in exploring for later use.

Alternatively, in place of using the video feed, a high-quality rendering of the multi-level structure and its surrounding area may be used, where the view point displayed is determined by a process similar or identical to that described above, one or more of the video input (whether in the form of a snapshot or a video feed) and/or the user's location. Other embodiments may allow a user to switch between a snapshot or video feed and the high-quality rendering. Indeed, the augmented reality embodiments may further be integrated with other embodiments, such as regular real estate marketplace embodiments, such that the user can later bring up the saved unit in the comfort of his own home, and review the relevant information using the three-dimensional rendering of the multi-level structure.

We claim:

1. A method for displaying a three-dimensional rendering of a multi-level structure having a plurality of units, comprising:
displaying a viewpoint of a three-dimensional rendering of the multi-level structure, wherein the viewpoint is capable of displaying information about a unit of the plurality of units of the multi-level structure that is visible within the viewpoint.

2. The method of claim 1 further comprising:
displaying information about at least one of the units of the plurality of units that is visible within the viewpoint by a method selected from the group: (1) displaying the information either within the rendering of the unit, (2) displaying the information adjacent to the rendering of the unit, (3) displaying the information on a window or box floating over, partially over or adjacent to the unit, and (4) by graphically marking the unit and (5) displaying the information and drawing a line from the information to the unit.

3. The method of claim 1 further comprising:
providing a user interface which presents a user with search options and allows the user to generate a search query containing search criteria selected from the search options;
upon receiving the search query from the user, communicating the search query to a database containing information about the plurality of units of the multi-level structure;
receiving from the database a set of selected units from the plurality of units of the multi-level structure which meet the search criteria in the search query;
updating the display of the viewpoint of the three-dimensional rendering of the multi-level structure to graphically mark each unit that is visible in the viewpoint of the three dimensional rendering of the multi-level structure and that is in the set of selected units.

4. The method of claim 3, wherein the multi-level structure is a building with a plurality of floors.

5. The method of claim 3, wherein the multi-level structure is a plurality of buildings, wherein at least one building of the plurality of buildings comprising more than one floor.

6. The method of claim 3, wherein the multi-level structure is a plurality of buildings, wherein at least one building of the plurality of buildings comprising more than one floor, and wherein the search options allow the user to search the plurality of units in the plurality of buildings by a method selected from the group of: by selecting the individual building in the plurality of buildings to be searched, by selecting multiple buildings of the plurality of buildings to be searched, and by searching all buildings in the plurality of buildings at once.

7. The method of claim 3, wherein at least one of the search options is selected from the group of unit status, minimum price, maximum price, minimum square footage, maximum square footage, minimum number of bedrooms, maximum number of bedrooms, a selected number of bedrooms, minimum number of bathrooms, a selected number of bathrooms, model type, unit number, rental price, lease term, pet policies, room rate, number of beds in the room, maximum occupancy, types of bed(s) in the room, amenities offered, price per square foot, unit owner, historical sales information, loan information, property taxes.

8. The method of claim 3, wherein the viewpoint of the three dimensional rendering of the multi-level structure can be manipulated by at least one operation selected from the group of: rotation of the viewpoint around the building, panning the viewpoint about the building, zooming the viewpoint in and zooming the viewpoint out, increase or decrease the angle of tilt with respect to the horizon.

9. The method of claim 3, wherein the graphical marking of the unit that is visible and in the list of selected units is done by a method selected from the group of (1) highlighting of the unit with a selected color; (2) outlining of the borders or edges of the unit with a selected color and displaying an icon over the unit; (3) adjusting its transparency relative to unmarked units; (4) using a texture; (5) using a pattern; (6) using an icon; (7) using an arrow; (8) using a line; (9) modifying the width of the lines along the edges of the unit; (10) using marking overlays; (11) using text; (12) using a photograph; (13) using a video; (14) using an animation; (15) using a marking overlay and (16) using a floor plan.

10. The method of claim 3, wherein a second unit in the list of selected units meeting the search criteria of the search query, is graphically marked differently from the unit in the list of search criteria.

11. The method of claim 3, wherein the user can generate a second search query, which results in a second list of selected units and wherein the viewpoint of the three-dimensional rendering of the multi-level structure wherein units that are visible in the viewpoint are graphically marked if they are in either: (1) in both the list of selected units and the second list of selected units, or alternatively (2) in either the list of selected units and the second list of selected units.

12. The method of claim 3 wherein
the viewpoint of a three-dimensional rendering of the multi-level structure is displayed on a three-dimensional page,
wherein a unit to be viewed can be selected by the user, such that when the user selects the unit to be viewed, additional information about the unit is displayed, and
wherein the additional information is displayed in a location selected from the group of (1) the three-dimensional page, inside of the three-dimensional rendering of the unit in the viewpoint, (2) the three dimensional page, adjacent to the unit in the viewpoint (3) on a window or text box floating over, partially over or adjacent to the unit, (4) on the three-dimensional by graphically marking the unit; (5) on the three-dimensional with arrows connecting the information to the unit; and (6) on a new page.

13. An electronic device displaying a three-dimensional rendering of a multi-level structure having a plurality of units, comprising:
a display device which is capable of displaying a viewpoint of a three-dimensional rendering of a multi-level structure, and is further capable of displaying information about a unit of the plurality of units of the multi-level structure;
an input device.

14. The electronic device of claim 13 wherein the device displays information about a unit of the plurality of units that is visible within the viewpoint by a method selected from the group of (1) displaying the information either within or the rendering of the unit, (2) displaying the information either within or adjacent to the rendering of the unit, (3) displaying the information on a window or text box floating over, partially over or adjacent to the unit, (4) graphically marking the unit and (5) displaying the information and drawing a line from the information to the unit.

15. The electronic device of claim 13, further comprising
a user interface and
wherein the user interface is capable of presenting a user with search options and allowing the user to generate a search query containing search criteria selected from the search options;
wherein the electronic device is capable of communicating with a database containing information about the plurality of units of the multi-level structure, such that upon receiving the search query from the user, the electronic device may communicate the search query to the database, and receive from the database a set of selected units;
wherein upon receiving the set of selected units from the database, the display device is further capable of rendering the multi-level structure such that each unit that is visible in the viewpoint of the three dimensional rendering, and that is in the set of selected units, is graphically marked.

16. A system displaying a three-dimensional rendering of a multi-level structure having a plurality of units, comprising:
database containing information about the plurality of units of the multi-level structure,
a computing device comprising a display device and capable of displaying a viewpoint of a three-dimensional rendering of the multi-level structure on the display device.

17. The system of claim 18 wherein the computing device further accesses the information about a unit of the plurality of units that is visible within the viewpoint from the database, and displays the information on the display device information by a method selected from the group of (1) displaying the information either within or the rendering of the unit, (2) displaying the information either within or adjacent to the rendering of the unit, (3) displaying the information on a window or box floating over, partially over or adjacent to the unit, (4) graphically marking the unit and (5) displaying the information and drawing a line from the information to the unit.

18. The system of claim 18 wherein the database is further capable of receiving a search query containing search criteria, and generating a list of selected units responsive to the search criteria, and wherein the display device is further capable of displaying each unit that is visible in the viewpoint of the three dimensional rendering of the multi-level structure and that is in the list of selected units such that it is graphically marked.

19. A computer program product, comprising a computer usable medium having a computer readable program code embodied therein, said computer readable program code adapted to be executed to implement three-dimensional rendering of a multi-level structure having a plurality of units, said method comprising:
displaying a viewpoint of a three-dimensional rendering of the multi-level structure, wherein the viewpoint is capable of displaying information about a unit of the plurality of units of the multi-level structure that is visible within the viewpoint.
